(19) United States
(12) Patent Application Publication
(10) Pub. No.: US 2016/0234129 A1
(43) Pub. Date: Aug. 11, 2016

(54) COMMUNICATION SYSTEM, QUEUE MANAGEMENT SERVER, AND COMMUNICATION METHOD

(71) Applicant: HITACHI, LTD., Tokyo (JP)

(72) Inventors: Hiroaki KONOURA, Tokyo (JP); Masafumi KINOSHITA, Tokyo (JP); Takafumi KOIKE, Tokyo (JP); Toshiyuki KAMIYA, Tokyo (JP)

(73) Assignee: HITACHI, LTD., Tokyo (JP)

(21) Appl. No.: 15/012,262

(22) Filed: Feb. 1, 2016

(30) Foreign Application Priority Data
Feb. 5, 2015 (JP) 2015-020933

(51) Int. Cl. H04L 12/911; H04L 12/24

(52) U.S. Cl. CPC H04L 47/781; H04L 41/12

(57) ABSTRACT

Provided is a communication system capable of sending and receiving signals. The communication system includes a plurality of data store servers each including a queue capable of storing signals and a queue management server capable of allocating signals to the plurality of data store servers. The queue management server holds distribution policy information that specifies policies to allocate signals to the plurality of data store servers. The queue management server is configured to determine to allocate a plurality of received signals to one queue in one of the plurality of data store servers based on the distribution policy information when the plurality of signals include in-order guarantee keys indicating that the plurality of signals are in need of in-order guarantee and the in-order guarantee keys of the plurality of signals are identical.

### CLAIM OF PRIORITY

The present application claims priority from Japanese patent application JP2015-020933 filed on Feb. 5, 2015, the content of which is hereby incorporated by reference into this application.

### BACKGROUND

This invention particularly relates to a communication system.

In the field of mission critical systems for supporting social infrastructure such as communications, financial activities, and traffics, distributed systems composed of multiple separate servers (hereinafter, referred to as distributed system) have been increasingly employed. Distributed systems have merits of high availability for not stopping services, high scalability for easy server addition, and low cost because of using commodity servers.

Particularly, high availability is the most important for mission critical systems. That is to say, mission critical systems have severe requirements for their service quality: for example, not only non-stop services but quick responses within a specified time.

Distributed systems, however, have difficulty in preserving the order of processing a variety of data (messages) transmitted all over the distributed system (hereinafter, referred to as in-order guarantee). A common distributed system processes data with multiple servers. Since the processing is not coordinated among the multiple servers, passing could occur in the processing.

An example of a distributed system may be a message system that receives, processes, and sends messages for registering or deregistering a subscriber of a communication carrier and for managing processing caused by such processing. Another example of a distributed system may be a message system that receives, processes, and sends messages for stock trading or currency exchange of a securities company.

Such message systems demand in-order guarantee to process received messages in order of arrival while eliminating passing of message processing in the overall message system. In addition to the in-order guarantee, these message systems also demand high availability as a feature of the distributed system.

Methods to attain the in-order guarantee for a message system have been proposed (for example, refer to JP 2004-177995 A and US 2013/0036427 A). JP 2004-177995 A discloses a message arrival sequence ensuring method for ensuring the order of arrival of messages including information of a sequence number indicating the order of sending from the message sender (see paragraphs [0006] and [0010]).

US 2013/0036427 A discloses a method that sets a time to send a message and processes the message after the specified time to send the message (see paragraphs [0002], [0018], and [0042]).

### SUMMARY

As described above, to apply distributed processing to the message system of a communication carrier or a securities company, in-order guarantee and high availability need to be implemented. However, the methods of the foregoing JP 2004-177995 A and US 2013/0036427 A cannot be applied because of the following reasons.

The method of assigning sequence numbers according to JP 2004-177995 A requires processing to retrieve a next sequence number from a first database holding the sequence numbers of the messages, to store an incoming message to a predetermined second database, and to determine whether the message is stored in duplicate in the second database through the message storing, for each of the messages including information of a sequence number indicating the order of sending from the message sender. This method causes access concentration on the second database; the second database might become a performance bottleneck in extending the system or a single point of failure in occurrence of a failure.

The method of specifying the time to send a message according to US 2013/0036427 A controls the message processing in individual clients to ensure the arrival order of the messages by setting a time and date to send to each message. However, in a message system for a communication carrier or securities company, it is difficult for the individual clients to check the times and dates to send messages with one another.

Accordingly, an object of this invention is to attain the in-order guarantee for the transmitted messages and the high availability in a message system employing distributed processing (hereinafter, distributed message system).

An aspect of this invention is a communication system capable of sending and receiving signals. The communication system includes a plurality of data store servers each including a queue capable of storing signals and a queue management server capable of allocating signals to the plurality of data store servers. The queue management server holds distribution policy information that specifies policies to allocate signals to the plurality of data store servers. The queue management server is configured to determine to allocate a plurality of received signals to one queue in one of the plurality of data store servers based on the distribution policy information when the plurality of signals include in-order guarantee keys indicating that the plurality of signals are in need of in-order guarantee and the in-order guarantee keys of the plurality of signals are identical.

This invention enables in-order guarantee in message processing in a distributed system.

The details of one or more implementations of the subject matter described in the specification are set forth in the accompanying drawings and the description below. Other features, aspects, and advantages of the subject matter will become apparent from the description, the drawings, and the claims.

### BRIEF DESCRIPTION OF THE DRAWINGS

FIG. 1 is a block diagram for illustrating a configuration of a distributed message system in an embodiment of this invention;

FIG. 2A is a block diagram for illustrating a hardware configuration of a queue management server in the embodiment;

FIG. 2B is an explanatory diagram for illustrating data held in a volatile storage unit of the queue management server in the embodiment;

FIG. 3A is a block diagram for illustrating a hardware configuration of a data store server in the embodiment;

FIG. 3B is an explanatory diagram for illustrating data held in a volatile storage unit of a representative data store server in the embodiment;

FIG. 4 is an explanatory diagram for illustrating a structure of a message to be sent from a message server to a queue management server in the embodiment;

FIG. 5 is an explanatory diagram for illustrating pre- and post-update queue information in each queue management server and pre- and post-update queue information in the representative data store server in the embodiment;

FIG. 6 is an explanatory diagram for illustrating a server pre- and post-update correspondence table in each queue management server and a server pre- and post-update correspondence table in the representative data store server in the embodiment;

FIG. 7 is an explanatory diagram for illustrating agreement information in each queue management server and agreement information in the representative data store server in the embodiment;

FIG. 8 is a sequence diagram for illustrating processing to extend the system in the embodiment;

FIG. 9 is a sequence diagram for illustrating processing to store a message sent from a message server to a data store server in the embodiment;

FIG. 10 is a sequence diagram for illustrating processing to acquire a message in a message server in the embodiment;

FIG. 11 is a sequence diagram for illustrating processing to update pre- and post-update queue information in each queue management server in the embodiment.

FIG. 12A is a flowchart of preparation of system extension to be performed by a queue management server in the embodiment;

FIG. 12B is a flowchart of determining whether the preparation for system extension is completed, which is to be performed by a queue management server in the embodiment;

FIG. 12C is a flowchart of system extension to be performed by a data store server in the embodiment;

FIG. 13 is a flowchart of storing a message sent from a message server to a data store server in the embodiment;

FIG. 14 is a flowchart of acquiring one or more messages for a message server in the embodiment;

FIG. 15A is an explanatory diagram for illustrating distributed queues in data store servers before and after system extension in the embodiment;

FIG. 15B is an explanatory diagram for illustrating distributed queues in data store servers after system extension in the embodiment; and

FIG. 16 is an explanatory diagram for illustrating an example of a screen for displaying the specifics of pre- and post-update queue information in the embodiment.

### DETAILED DESCRIPTION OF THE EMBODIMENTS

Hereinafter, embodiments are described with reference to the drawings.

The in-order guarantee in the embodiments particularly refers to the in-order guarantee for the messages in a distributed message system.

The distributed system has a merit of high scalability for allowing easy addition of a server. Accordingly, the distributed message system in this embodiment ensures high scalability of a distributed system while attaining the in-order guarantee for the messages.

In preparation for extending a distributed system by, for example, adding a server to the distributed message system, methods to achieve a distributed system having high availability have already been proposed (for example, JP 2013-025497 A and US 2013/0290499 A).

JP 2013-025497 A discloses a distributed processing system employing consistent hashing; the distributed processing system includes multiple servers for managing data and a load balancer for allocating requests received from client machines to the multiple servers based on consistent hashing to restrain the load to the overall system caused by relocation of existing data after addition of a cluster member (see paragraphs [0009] and [0010] in JP 2013-025497 A).

US 2013/0290499 A discloses a method of adding a server using a scaling controller for monitoring the load and the performance of the servers (see paragraph [0004] in US 2013/0290499 A).

These techniques achieve highly-available system extension of a distributed system but do not achieve in-order guarantee. The distributed system disclosed in JP 2013-025497 A has difficulty in managing the message creation dates and times, so that the in-order guarantee is hardly attained. US 2013/0290499 A does not refer to basic processing related to extension such as allocation or relocation of messages when the extension is in process.

This embodiment describes the following distributed message system as an example of a distributed message system that allows extension or reduction and ensures in-order guarantee in message processing. Hereinafter, extension or reduction of the distributed message system is generally referred to as system update.

A message in this embodiment is a set of information to be stored in a storage device. The message in this embodiment is a signal for transmitting data such as a cellphone e-mail, subscriber management data, or financial data for stock trading or currency exchange; the message is data in byte string.

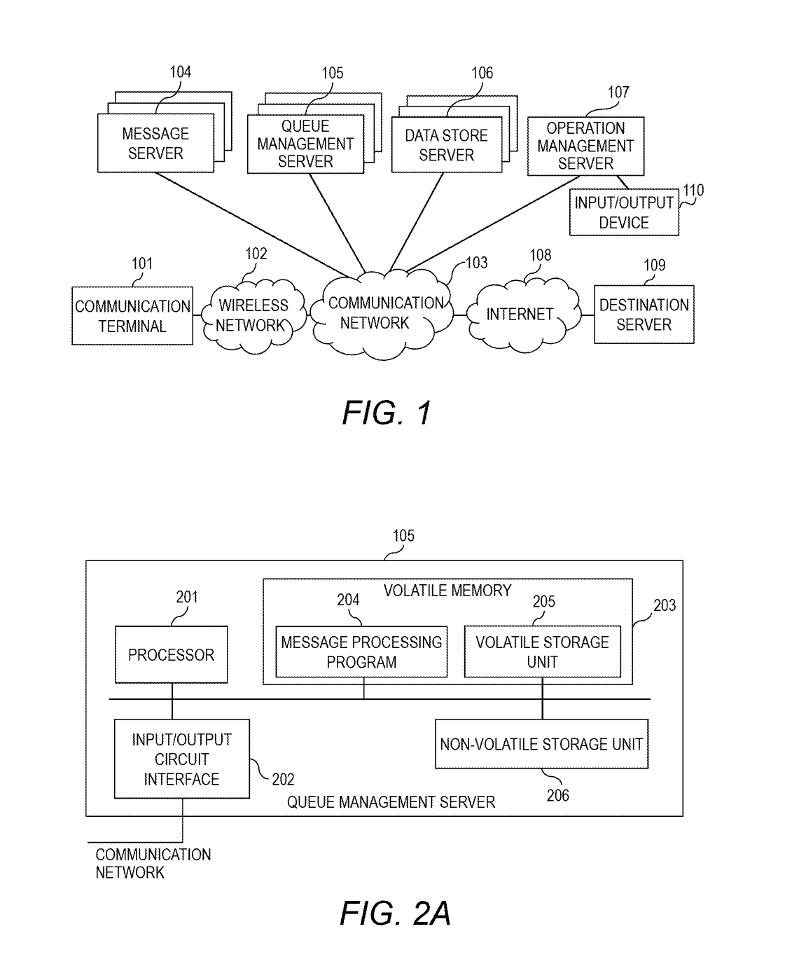

FIG. 1 is a block diagram for illustrating a configuration of a distributed message system in this embodiment.

The distributed message system in this embodiment is constructed in a communication network 103 of a social infrastructure company and includes a message server 104, a queue management server 105, and a data store server 106. The distributed message system in this embodiment connects to a communication terminal 101 via the communication network 103 and a wireless network 102 and connects to a destination server 109 via the communication network 103 and the Internet 108. The distributed message system in this embodiment connects to an operation management server 107 via the communication network 103.

The communication terminal 101 is a terminal device such as a cellphone terminal, a tablet terminal, or a PC that is capable of receiving and sending messages. The wireless network 102 is a wireless network managed by the social infrastructure company.

The communication network 103 is a network and network facilities for relaying communications between the communication terminal 101 and the destination server 109. The communication network 103 transfers a signal from the wireless network 102 to the destination server 109 via the Internet 108 and transfers a signal from the Internet 108 to the communication terminal 101 via the wireless network 102.

The wireless network 102 and the communication network 103 are managed by the social infrastructure company that manages the message server 104, the queue management server 105, the data store server 106, and the operation management server 107.

The distributed message system in this embodiment is configured with a plurality of message servers 104, a plurality of queue management servers 105, and a plurality of data store servers 106. These servers are connected in a mesh topology.

It should be noted that a message server 104 may be configured with two servers of a transmission server and a receiving server. A queue management server 105 may be configured with two servers of a transmission server and a receiving server.

Each of the message servers 104, the queue management servers 105, the data store servers 106, and the operation management server 107 may be a server apparatus configured with a physical computer or may be configured with a virtual machine. Alternatively, one server apparatus may hold a server program for implementing the functions of at least two kinds of servers and perform the functions of the distributed message system in this embodiment.

For example, one server apparatus may function as a queue management server 105 and a data store server 106 or function as a plurality of data store servers 106. Otherwise, one server apparatus may function as a message server 104 and a queue management server 105. The system configuration in this embodiment is not limited to the configuration illustrated in FIG. 1 but is applicable to a distributed message system having a different configuration.

Each message server 104 receives a message sent from the communication terminal 101 and transfers the message to a queue management server 105. The message server 104 further transfers a message received from a queue management server 105 to the communication terminal 101 or the destination server 109. The queue management server 105 reads the message received from the message server 104 and allocates the message to a data store server 106.

Each queue management server 105 receives a message sent from the communication terminal 101 via a message server 104 and stores the received message to a storage area called queue. The queue management server 105 relays the message using store-and-forward that stores first and then sends messages sequentially. This method enables the queue management server 105 to achieve leveling of the amount of information entering the system and responding within a specific time so as not to make users wait for a long time.

The queue management server 105 in this embodiment allocates the messages received from the message servers 104 to the data store servers 106 which hold queues.

Each data store server 106 is an apparatus to store messages using, for example, key-value store or data grid. The distributed message system in this embodiment includes a plurality of data store servers 106 inclusive of one representative data store server.

The representative data store server is a data store server 106 for holding information to perform system update in the distributed message system in this embodiment.

Each data store server 106 replicates a message and distributes the replicated message to at least one other data store server 106 to hold the message redundantly, achieving the persistency of the message data. The data store server 106 performs processing to store, update, or delete a message in cooperation with the other data store servers 106 holding (or to hold) the message.

The data store server 106 in this description employs key-value store that manages messages with pairs of a key and a value. The data store server 106 outputs a message requested by a message server 104 via a queue management server 105 in accordance with the request.

The operation management server 107 instructs the queue management servers 105 and the data store servers 106 about system update. The operation management server 107 may be connected with an input/output device 110. The input/output device 110 includes an input device for the operator or administrator of the distributed message system in this embodiment to input instructions and an output device for outputting results of processing in the distributed message system. The input/output device 110 may include a keyboard, a mouse, a monitor, and/or a printer.

This embodiment is described assuming that the distributed message system is provided in a social infrastructure company; the message servers 104 or the queue management servers 105 may perform processing other than the above-described processing, such as authentication, billing, conversion of messages, and/or congestion control.

Each message in the following description is routed from a communication terminal 101 to the communication terminal 101 or the destination server 109 via a message server 104, a queue management server 105, a data store server 106, a queue management server 105, and a message server 104.

However, the processing in this embodiment is not limited to this; the message may be transmitted in any route as far as the message goes through the distributed message system in this embodiment. The distributed message system in this embodiment is not limited to a communication service of a social infrastructure company but is applicable to messages (or data) to be sent to sensors, vehicles, or devices such as meters connected with the wireless network 102. This embodiment is also applicable to a network such as a wired network or a smart grid, instead of the wireless network 102.

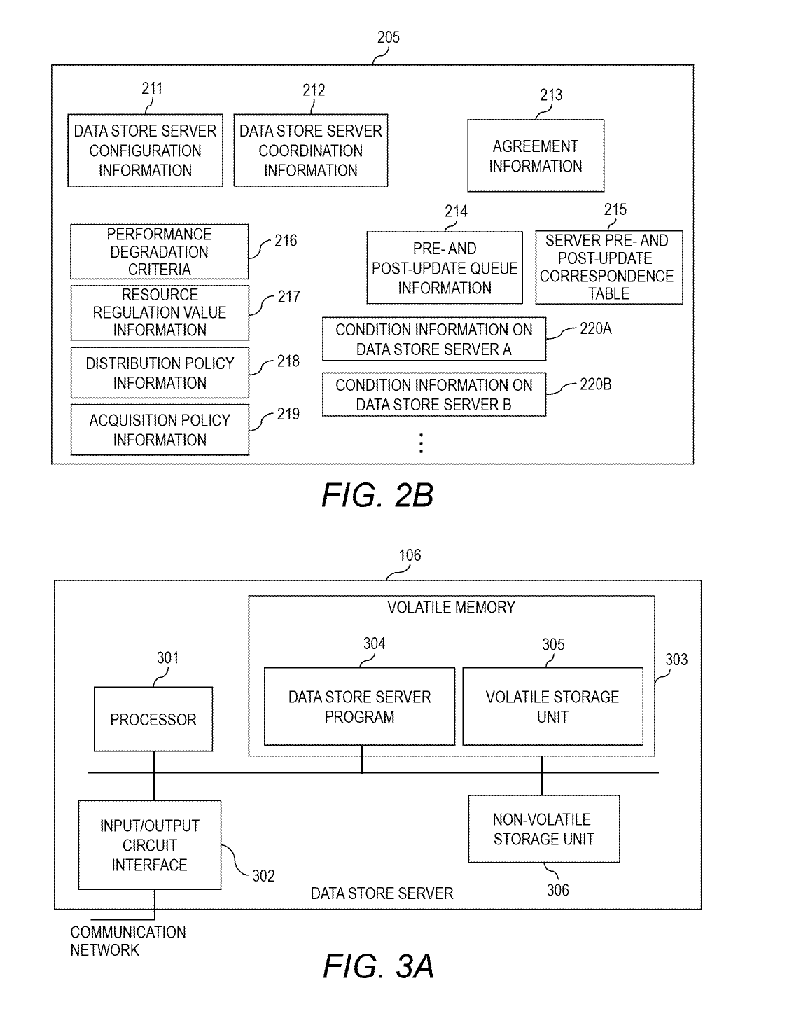

FIG. 2A is a block diagram for illustrating a hardware configuration of a queue management server 105 in this embodiment.

Each queue management server 105 includes a processor 201, an input/output circuit interface 202, a volatile memory 203, a non-volatile storage unit 206, and an internal communication line (for example, a bus) for connecting these components.

The processor 201 is a computing device and a controller. The processor 201 executes programs held in the volatile memory 203 to implement the functions of the queue management server 105.

The volatile memory 203 may include a RAM, which is a volatile storage element. The RAM is a high-speed and volatile storage element like a DRAM (Dynamic Random Access Memory) and temporarily stores programs stored in an auxiliary storage device and data to be used to run the programs.

The non-volatile storage unit 206 may be a ROM, which is a non-volatile storage element, or a large-capacity and non-volatile storage device such as a magnetic storage device (HDD) or a flash memory (SSD). The non-volatile storage unit 206 may store the programs to be executed by the processor 201 and the data to be used to run the programs. The programs may be retrieved from the non-volatile storage unit 206 as necessary, loaded to the volatile memory 203, and executed.

The input/output circuit interface 202 is an interface for communicating with the communication network 103.

The volatile memory 203 includes a message processing program 204 and a volatile storage unit 205. The message processing program 204 is a program for implementing distributed processing functions such as storing a message to a data store server 106 and a function of processing a message. The message processing program 204 may be configured with a single program or may include a plurality of subprograms.

The message processing program 204 may be stored in advance in the volatile memory 203 or the non-volatile storage unit 206 or otherwise, may be loaded to the volatile memory 203 or the non-volatile storage unit 206 via a not-shown removable storage medium (for example, a CD-ROM or a flash memory) or a communication medium (that is, a network and a digital signal or a carrier wave transmitted in the network).

The functions of the queue management server 105 described below are implemented by the processor 201 executing the message processing program 204.

The volatile storage unit 205 is a storage area to be used by the message processing program 204 when the program 204 performs processing. The message processing program 204 may have such a storage area to be used when the program 204 performs processing within the storage area where the program itself is stored.

The non-volatile storage unit 206 stores a log outputted by the message processing program 204 and data such as configuration files to be used by the message processing program 204.

FIG. 2B is an explanatory diagram for illustrating data held in the volatile storage unit 205 of the queue management server 105 in this embodiment.

The volatile storage unit 205 includes data store server configuration information 211, data store server coordination information 212, agreement information 213, pre- and post-update queue information 214, server pre- and post-update correspondence table 215, performance degradation criteria 216, resource regulation value information 217, distribution policy information 218, acquisition policy information 219, and condition information 220 on individual data store servers.

The data store server configuration information 211 stores correlation information among the data store servers 106 and operating information on the data store servers 106. The correlation information among the data store servers 106 includes information indicating the key ranges for the keys of the data held by individual data store servers 106 (key range assignment information for data store servers 106) and information indicating whether the individual data store servers 106 are a master or a slave for each key range.

The operating information on the data store servers 106 includes information (such as IP addresses) for identifying individual data store servers 106, the number of data store servers 106, information indicating whether the individual data store servers 106 are operating normally, and redundancy levels of the messages held by the individual data store servers 106.

The message processing program 204 in this embodiment directly stores a message to the data store server 106 determined to allocate the message. The data store servers 106 in this embodiment do not relocate messages among the data store servers 106 because of system update.

The data store server coordination information 212 is information directly exchanged among the data store servers 106. The information 212 includes operating information and correlation information on the data store servers 106, like the data store server configuration information 211.

The message processing program 204 may determine whether any data store servers 106 has degraded in performance with reference to either one or both of the data store server coordination information 212 and the data store server configuration information 211. In the following, the message processing program 204 in this embodiment uses the data store server configuration information 211 in performance degradation determination.

The agreement information 213 is used in system update and indicates whether all the queue management servers 105 have completed preparation for the system update. The agreement information 213 includes information (such as IP addresses) for identifying the queue management servers 105 that are in agreement with the system update.

The completion of preparation for system update means completion of preparation to update the data store server configuration information 211 and server pre- and post-update correspondence table 215. The agreement information 213 is synchronized with the agreement information 313 (to be described later) held by the representative data store server.

The agreement information 213 includes, for example, a sequence number indicating how new the information is, the identifier of the system update to be performed, or identifiers (IP addresses) of the queue management servers 105 that have completed the preparation for system update, for information indicating that the preparation for system update is completed.

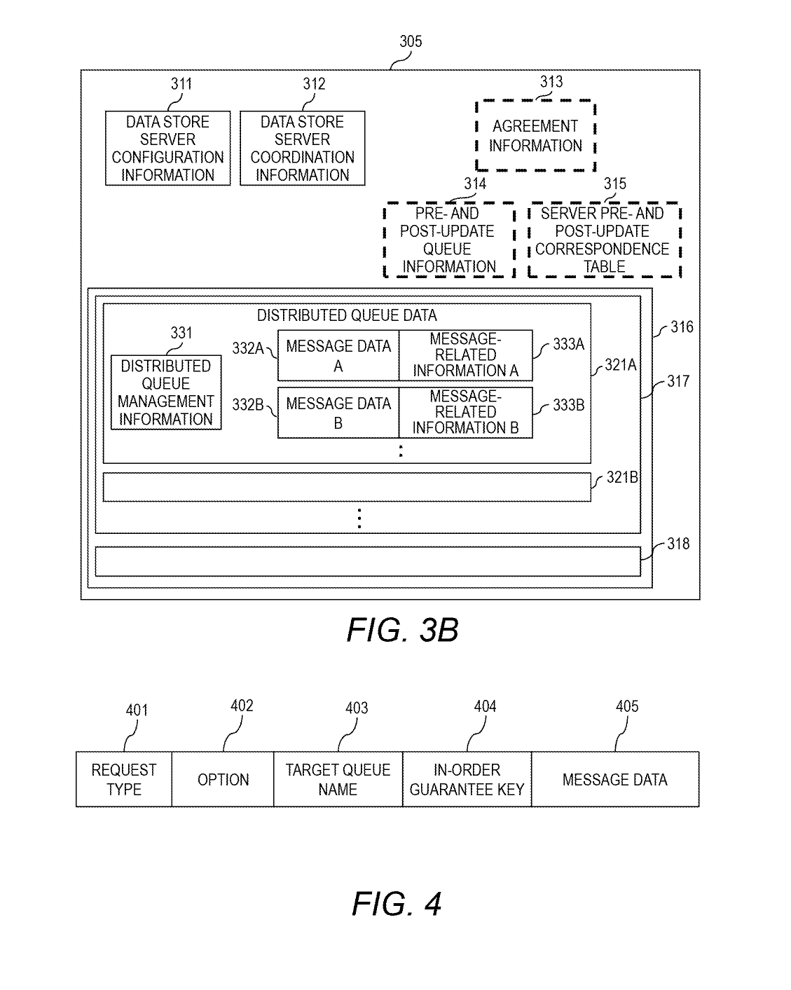

The pre- and post-update queue information 214 is information for the distributed message system to unify the management of the number of messages stored in the queues (distributed queue data groups 321 shown in FIG. 3B to be described later) held by the data store servers 106 before and after execution of system update. In particular, the pre- and post-update queue information 214 includes information about the queues before execution of system update and information about the queues after execution of the system update. The pre- and post-update queue information 214 is synchronized with pre- and post-update queue information held by the representative data store server.

The server pre- and post-update correspondence table 215 indicates correspondence relations between the data store servers 106 before system update and the data store servers 106 after system update in the case where the data allocation space in consistent hashing changes at the system update.

The server pre- and post-update correspondence tables 215 in the distributed message system are synchronized with one another by the message processing programs 204.

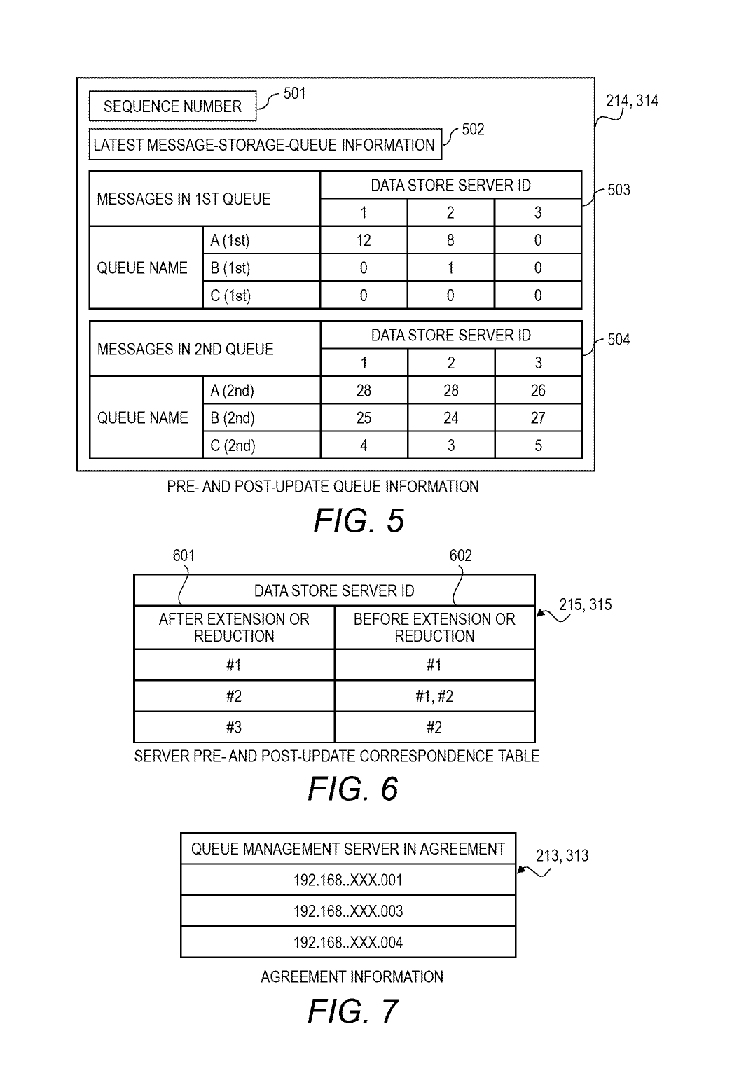

The method of synchronizing the tables is as follows: the message processing program 204 in one of the queue management servers 105 updates its server pre- and post-update correspondence table 215 and stores the updated server pre- and post-update correspondence table 215 to the representative data store server as the server pre- and post-update correspondence table 315. The details of the server pre- and post-update correspondence table 215 will be described later with FIG. 6.

The performance degradation criteria 216 is criteria (thresholds) for the message processing program 204 to determine whether any data store server 106 has degraded in performance. For example, the performance degradation criteria 216 include thresholds of the processing time, the number of connections, the number of messages to be processed concurrently, the number of messages in the queues, and the response time for each request type of received messages to determine the performance degradation.

The request type means the type of the instruction to process the message for a data store server 106, such as message acquisition or message storage.

The message processing program 204 determines whether any data store server 106 has degraded in performance by comparing the values in the data store server configuration information 211 acquired through communications with the data store servers 106 with the performance degradation criteria 216.

The resource regulation value information 217 includes a plurality of values for different status such as at normal time and “at detection of performance degradation”. The message processing program 204 prevents depletion of the resources of a data store server 106 that has degraded in performance by not sending requests for processing to the data store server 106.

The distribution policy information 218 provides policies for the message processing program 204 to distribute (allocate) messages to the queues in the data store servers 106. The distribution policy information 218 in this embodiment is based on the consistent hashing, for example, and specifies a method to assign a queue in one data store server 106 for one in-order guarantee key (which is included in a message).

The data store servers 106 in this embodiment have separate queues for different destinations of messages in the whole system. The queue management servers 105 select a specific data store server 106 based on the in-order guarantee key attached to a message and the method such as consistent hashing specified in the distribution policy information 218.

To store a message to a queue, the message processing program 204 acquires a data store server 106 to allocate the message with reference to the distribution policy information 218. In this processing, the message processing program 204 may select a queue in a specific data store server 106 in accordance with the allocation method indicated in the distribution policy information 218 if some value is set to the in-order guarantee key. However, if no value is set to the in-order guarantee key, the message processing program 204 may select a queue in a data store server 106 using a different allocation method (such as round-robin).

The message processing program 204 creates part of the information in the distribution policy information 218, such as the configuration of the data allocation space based on the consistent hashing (specifically, a list of the queues in the data store servers 106), based on the configuration of the data store servers 106 indicated in the data store server configuration information 211. Accordingly, when the data store server configuration information 211 is updated in system update, the distribution policy information 218 is also updated.

The acquisition policy information 219 indicates data store servers 106 from which the queue management server 105 can acquire messages (condition information 220 on data store servers) and the priority levels of the data store servers 106 in acquiring messages. Specifically, the acquisition policy information 219 provides information indicating that the queue management server 105 should acquire messages from all or a part of the data store servers 106 and if a plurality of data store servers 106 are specified, from which data store server 106 the queue management server 105 should acquire a message first or otherwise, should acquire a message first from the data store server 106 having the largest number of messages.

The message processing program 204 can locate the data store server 106 from which to acquire a message currently (after update) with reference to the acquisition policy information 219. The message processing program 204 further identifies a data store server 106 to store messages after the update and a data store server 106 corresponding to this data store server 106 that have stored messages before the update with reference to the server pre- and post-update correspondence table 215.

Further, the message processing program 204 selects a data store server 106 from which to acquire a message, the data store server 106 to store messages after the update or the data store server 106 that have stored messages, with reference to the pre- and post-update queue information 214.

The condition information 220 on a data store server includes information on the conditions of the data store server 106, such as assigned key range information, operating server, operating information, a distributed queue list, and information on redundancy of the data.

FIG. 3A is a block diagram for illustrating a hardware configuration of a data store server 106 in this embodiment.

Each data store server 106 includes a processor 301, an input/output circuit interface 302, a volatile memory 303, a non-volatile storage unit 306, and an internal communication line (for example, a bus) for connecting these components.

The processor 301 is a computing device and a controller. The processor 301 executes programs held in the volatile memory 303 to implement the functions of the data store server 106.

The volatile memory 303 may include a RAM, which is a volatile storage element. The RAM is a high-speed and volatile storage element like a DRAM (Dynamic Random Access Memory) and temporarily stores programs stored in an auxiliary storage device and data to be used to run the programs.

The non-volatile storage unit 306 may be a ROM, which is a non-volatile storage element, or a large-capacity and non-volatile storage device such as a magnetic storage device (HDD) or a flash memory (SSD). The non-volatile storage unit 306 may store the programs to be executed by the processor 301 and the data to be used to run the programs. The program may be retrieved from the non-volatile storage unit 306 as necessary, loaded to the volatile memory 203, and executed.

The input/output circuit interface 302 is an interface for communicating with the communication network 103.

The volatile memory 303 includes a data store server program 304 and a volatile storage unit 305. The data store server program 304 is a program for processing messages. The data store server program 304 may be configured with a single program or may include a plurality of subprograms.

The data store server program 304 may be stored in advance in the volatile memory 303 or the non-volatile storage unit 306 or otherwise, may be loaded to the volatile memory 303 or the non-volatile storage unit 306 via a not-shown removable storage medium (for example, a CD-ROM or a flash memory) or a communication medium (that is, a network and a digital signal or a carrier wave transmitted in the network).

The functions of the data store server 106 described below are implemented by the processor 301 executing the data store server program 304.

The volatile storage unit 305 is a storage area to be used by the data store server program 304 when the program 304 performs processing. The data store server program 304 may have such a storage area to be used when the program 304 performs processing within the storage area where the program itself is stored.

The non-volatile storage unit 306 stores a log outputted by the data store server program 304 and data such as configuration files to be used by the data store server program 304.

FIG. 3B is an explanatory diagram for illustrating data held in the volatile storage unit 305 of the representative data store server in this embodiment.

The volatile storage unit 305 of the data store server 106 includes data store server configuration information 311, data store server coordination information 312, and a data store area 316. The volatile storage unit 305 of the representative data store server additionally includes agreement information 313, pre- and post-update queue information 314, and server pre- and post-update correspondence table 315.

The non-volatile storage unit 306 may store the data store server configuration information 311, the data store server coordination information 312, the agreement information 313, the pre- and post-update queue information 314, and the server pre- and post-update correspondence table 315, and the information in the data store area 316. And the data store server program 304 may retrieve information from the non-volatile storage unit 306 as necessary.

The data store server configuration information 311 is synchronized with the data store server configuration information 211 in FIG. 2B to have the identical information. That is to say, the data store server configuration information 311 stores the correlation information among the data store servers 106 and operating information on the data store servers 106.

The data store server configuration information 311 is referred to by the programs of the data store server 106; accordingly, the data store server configuration information 311 can have a different data format from the data store server configuration information 211 as far as the information is identical.

The data store server coordination information 312 is synchronized with the data store server coordination information 212 in FIG. 2B to have the identical information. That is to say, the data store server coordination information 312 stores correlation information among the data store servers 106 and operating information on the data store servers 106. The data store server programs 304 of the data store servers 106 exchange the data store server coordination information 312 with one another to update their own data store server configuration information 311.

The agreement information 313 has information identical to the agreement information 213 in FIG. 2B. The data store servers 106 other than the representative data store server may hold slave information of the agreement information 313. The agreement information 313 of the representative data store server is shared by the queue management servers 105.

Upon receipt of a system update request and completion of preparation for the system update, the message processing program 204 of each queue management server 105 stores information indicating that the queue management server 105 has received a system update request and completed preparation for the system update to the agreement information 313 in the representative data store server.

When all the queue management servers 105 have updated the agreement information 313 in the representative data store server, the agreement information 313 indicates that all the queue management servers 105 have completed preparation for the system update and the system is ready to start processing with the post system update configuration.

Each queue management server 105 acquires the agreement information 313 from the data store server 106 and updates its own agreement information 213 with the acquired agreement information 313 upon receipt of a message processing request or at scheduled update. And if the agreement information 213 indicates that all the queue management servers 105 have completed preparation for system update, the queue management server 105 starts processing with the post system upgrade configuration.

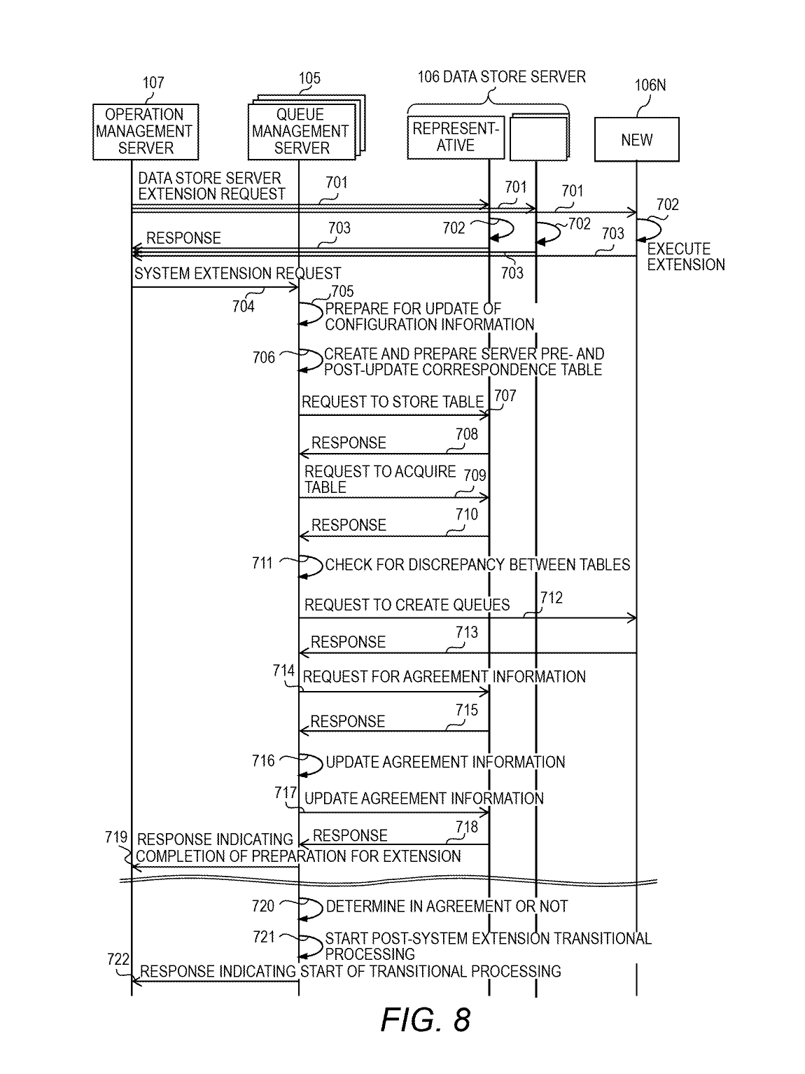

The distributed message system in this embodiment does not shift to the status of post system update until all the queue management servers 105 store information indicating completion of preparation for the system update to the agreement information 313 in the data store server 106. The sequence of updating the system will be described later with FIG. 8.

The pre- and post-update queue information 314 is synchronized with the pre- and post-update queue information 214 to have the identical information. The pre- and post-update queue information 314 is stored in the representative data store server and shared by the queue management servers 105.

When at least one of the message processing programs 204 of the queue management servers 105 updates its pre- and post-update queue information 214, the message processing program 204 stores the information in the updated pre- and post-update queue information 214 to the pre- and post-update queue information 314 in the representative data store server.

The server pre- and post-update correspondence table 315 has information identical to the server pre- and post-update correspondence table 215 in FIG. 2B. The server pre- and post-update correspondence table 315 stored in the representative data store server is shared by the queue management servers 105.

The data store area 316 is an area for storing messages sent together with storage requests to the data store server 106 from queue management servers 105. The data store server 106 in this embodiment employs key-value store; the data store area 316 stores messages (values) and keys associated with the message data.

The data store area 316 includes a 1st queue 317 and a 2nd queue 318. The 1st queue 317 and the 2nd queue 318 are to manage where to store or acquire the messages separately before and after system update. The 1st queue 317 and the 2nd queue 318 are generally referred to as distributed queues.

The 1st queue 317 and the 2nd queue 318 include a plurality of distributed queue data groups 321. A distributed queue data group 321 is a storage area for a group of messages in need of in-order guarantee. A distributed queue data group 321 stored in the 1st queue 317 is paired with a distributed queue data group 321 stored in the 2nd queue 318.

Each distributed queue data group 321 is held by a plurality of data store servers 106 redundantly. Each distributed queue data group 321 includes distributed queue management information 331 and a plurality of pairs of message data 332 and message-related information 333.

The 1st queue 317 and the 2nd queue 318 each have distributed queue data groups 321 having the identical target queue names (identifiers). When storing a message to a data store server 106, the message processing program 204 of a queue management server 105 designates a distributed queue of the 1st queue 317 or the 2nd queue 318 to store the message. The data store server program 304 stores the message to a distributed queue data group 321 in accordance with the target queue name (identifier) included in the message and the distributed queue designated by the message processing program 204.

The distributed queue management information 331 is information for managing a plurality of pairs of message data 332 and message-related information 333 included in the distributed queue data group 321. The data store server program 304 implements the function of a first-in and first-out queue with reference to the distributed queue management information 331.

Specifically, the distributed queue management information 331 includes the identifier of the distributed queue data group 321, information indicating that the distributed queue data group 321 is a master or a slave, and information indicating the processing order of message data 332 such as the storage (arrival) order of the message data 332.

The distributed queue management information 331 further includes the maximum number of messages that can be stored in the distributed queue data group 321 (or the capacity in data size for the distributed queue data group 321), the number and the size of the messages stored in the distributed queue data group 321, and information for identifying the message data 332 under exclusive control for a plurality of message processing programs 204 to retrieve messages one by one.

Since the distributed queue management information 331 indicates the storage order of the message data 332, the message processing program 204 can retrieve the messages in accordance with the storage order of the messages. The data storage server program 304 can therefore retrieve the message stored earliest from the distributed queue data 321, attaining the in-order guarantee.

Referring to the distributed queue management information 331 leads to prohibiting a message processing program 204 from retrieving a message retrieved by another message processing program 204 for a certain time. As a result, the message is prevented from being processed for multiple times.

In one distributed queue data group 321, the other messages are not processed until one message has been processed. Accordingly, the data store server program 304 gathers the messages in need of in-order guarantee to a single distributed queue data group 321 in storing messages to ensure the correct processing order of the messages.

The data store server program 304 updates the distributed queue management information 331 upon receipt of instruction to store or delete a message from a queue management server 105. The message processing program 204 in each queue management server 105 periodically acquires and aggregates the distributed queue management information 331 in the plurality of data store servers 106 to create pre- and post-update queue information 214.

A piece of message data 332 is data of a message sent from a message server 104 and forwarded to the data store server 106 through message allocation by a queue management server 105. The message data 332 corresponds to a value.

A piece of message-related information 333 includes information attached to a forwarded message. Specifically, the message-related information 333 includes an in-order guarantee key. The data store server program 304 processes a message using an instruction from a queue management server 105 and the message-related information 333.

In preparation for system update, the message processing program 204 in each queue management server 105 updates the data allocation space in the distribution policy information 218. For this reason, the message processing program 204 allocates messages including the same in-order guarantee key to different storage locations between before and after system update.

The message processing program 204 switches the distributed queues for storing messages between the 1st queue 317 and the 2nd queue 318 at system update to distribute the messages in need of in-order guarantee before and after system update.

In this embodiment, two queues of the 1st queue 317 and the 2nd queue 318 switches the roles to each other at each system update. However, the data store server 106 may have three or more distributed queues such as a 3rd queue and a 4th queue and use the 3rd queue and the 4th queue in system update different from the system update being processed.

The structure of the messages sent from the message servers 104 to the data store servers 106 via the queue management servers 105 will be described with FIG. 4.

FIG. 4 is an explanatory diagram for illustrating a structure of a message to be sent from a message server 104 to a queue management server 105.

The functions of a message server 104 may be implemented by at least one processor executing a program with a memory. The message server 104 may be a computer as illustrated in FIG. 2A or 3A. The functions of the message server 104 described hereinbelow are performed by the program included in the message server 104 or a physical integrated circuit for implementing the functions of the message server 104.

A message includes a request type 401, an option 402, a target queue name 403, an in-order guarantee key 404, and message data 405. The request type 401 indicates the processing requested for the message, such as storing, acquiring, deleting, or comparing.

The option 402 is an area capable of storing a parameter specific to the request type. For example, in the case where the message is an acquisition request, the option 402 stores the number of messages to be acquired. In the case where the message is a message storage request, the option 402 may be an area to store the date and time of sending the message. The message server 104 stores the parameter to the option 402.

The target queue name 403 stores the queue name (identifier) of a queue (a pair of distributed queue data groups 321 in the 1st queue 317 and the 2nd queue 318) to be the location of the message processing such as storing, acquiring, deleting, or comparing. The message server 104 stores the identifier of the queue to the target queue name 403.

The in-order guarantee key 404 stores an identifier assigned to a plurality of messages intended to attain in-order guarantee to indicate that the message is in need of in-order guarantee. The in-order guarantee key 404 is stored to the message-related information 333 in the distributed queue data 321. The message server 104 stores the value to the in-order guarantee key 404.

The message processing program 204 in a queue management server 105 selects a data store server 106 to allocate a received message based on the target queue name 403 and the in-order guarantee key 404 in the message and the distribution policy information 218.

The queue management server 105 uniquely determines a distributed queue in a specified data store server 106 based on the in-order guarantee key included in the message and further, the processing order is controlled within the distributed queue of the data store server 106, so that the distributed message system in this embodiment ensures the in-order guarantee for the message.

For example, when each destination server 109 requires to acquire messages in attaining in-order guarantee, the message server 104 stores the domain name of a destination server 109 (or an identifier uniquely associated with a destination server 109) to the in-order guarantee key 404. The in-order guarantee key 404 in this embodiment does not need to include information indicating the order.

Another case is a message system of a communication carrier or a securities company in which a large number of messages are in need of attaining in-order guarantee. For example, in a case of a message system of a securities company where messages are in need of attaining in-order guarantee for each different stock brand, the message server 104 assigns an in-order guarantee key specific to the stock brand designated in the message data 405 and stores the assigned in-order guarantee key to the in-order guarantee key 404. This configuration enables each queue management server 105 to distribute and store messages to all the data store servers 106.

If a certain message does not need in-order guarantee, the message server 104 sets a null value or a predetermined value to the in-order guarantee key 404. As a result, the message processing program 204 applies a message allocation method other than the in-order guarantee, such as round-robin, in accordance with the distribution policy information 218.

The message data 405 stores the data of the message received from the communication terminal 101 and to be forwarded. The message to be forwarded can be data in any representation format such as texts or a file. The message data 405 is a byte string (value).

In processing a received message, the message processing program 204 determines a pair of distributed queue data groups 321 in a data store server 106 where to allocate the message based on the request type 401, the option 402, the target queue name 403, and the in-order guarantee key 404. Simultaneously, the message processing program 204 selects which queue to allocate the message, the 1st queue 317 or the 2nd queue 318.

FIG. 5 is an explanatory diagram for illustrating the pre- and post-update queue information 214 in each queue management server 105 and the pre- and post-update queue information 314 in the representative data store server.

Since the pre- and post-update queue information 214 and the pre- and post-update queue information 314 have the identical information, the following is a description about the configuration of the pre- and post-update queue information 314.

The pre- and post-update queue information 314 includes a sequence number 501, latest message-storage-queue information 502, a 1st queue message counter table 503, and a 2nd queue message counter table 504.

The sequence number 501 is a value for indicating the update status of the pre- and post-update queue information 314 (how new the pre- and post-update queue information 314 is). The message processing program 204 in this embodiment adds one to the sequence number 501 each time the program 204 updates the pre- and post-update queue information 314 (214).

The message processing program 204 of each queue management server 105 periodically compares the sequence number 501 of the local pre- and post-update queue information 214 with the sequence number 501 of the pre- and post-update queue information 314 and if the sequence number 501 of the pre- and post-update queue information 214 is smaller (meaning older) than the sequence number 501 of the pre- and post-update queue information 314, the message processing program 204 copies the pre- and post-update queue information 314 of the data store server 106 to the local pre- and post-update queue information 214.

This is because the pre- and post-update queue information 314 is updated by a plurality of queue management servers 105 and always is in the latest state and the queue management server 105 may have old pre- and post-update queue information 214.

Contrarily, if the sequence number 501 of the pre- and post-update queue information 214 is identical to the sequence number 501 of the pre- and post-update queue information 314, the message processing program 204 and the data store server program 304 further update the pre- and post-update queue information 214 and the pre- and post-update queue information 314 into the latest state. The pre- and post-update queue information 214 and the pre- and the post-update queue information 314 are updated based on the distributed queue management information 331 held by each data store server 106.

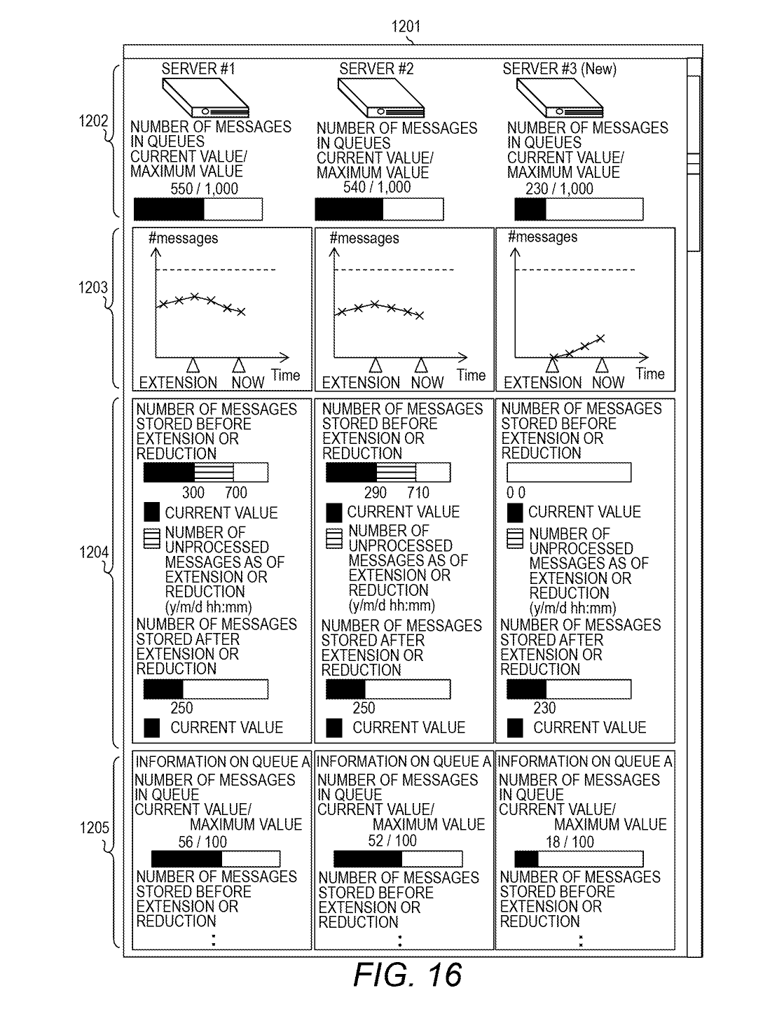

The message processing program 204 periodically stores the pre- and post-update queue information 214 including information about system update to the volatile storage unit 205 or the non-volatile storage unit 206 as a log, so that the message processing program 204 can display the information as shown in FIG. 16 using a GUI.

The latest message-storage-queue information 502 indicates which queue is the current storage location for the messages, the 1st queue 317 or the 2nd queue 318.

The 1st queue message counter table 503 indicates the number of messages stored in the 1st queues 317 in the data store servers 106. The 2nd queue message counter table 504 indicates the number of messages stored in the 2nd queues 318 in the data store servers 106.

In the 1st queue message counter table 503 and the 2nd queue message counter table 504 in FIG. 5, each row represents a distributed queue data group 321 and each column represents a data store server 106. This structure enables the 1st queue message counter table 503 and the 2nd queue message counter table 504 to indicate the number of messages in each distributed queue data group 321 in each data store server 106.

It should be noted that the 1st queue message counter table 503 and the 2nd queue message counter table 504 may hold the number of messages in any format other than the table format; for example, they may hold the number of messages in text format.

When a message processing program 204 receives a request to add or delete a distributed queue data group 321 from a message server 104, the message processing program 204 instructs the data store server 106 to add or delete the distributed queue data group 321 in accordance with the request and further, instructs the data store server 106 to add or delete a row of the 1st queue message counter table 503 and the 2nd queue message counter table 504.

When a message processing program 204 receives a system update request from the operation management server 107, the message processing program 204 adds or deletes a column corresponding to the data store server 106 to be added or removed in the 1st queue message counter table 503 and the 2nd queue message counter table 504.

FIG. 6 is an explanatory diagram for illustrating the server pre- and post-update correspondence table 215 in each queue management server 105 and the server pre- and post-update correspondence table 315 in the representative data store server in this embodiment.

Since the server pre- and post-update correspondence table 215 and the server pre- and post-update correspondence table 315 have the identical information, the following is a description about the configuration of the server pre- and post-update correspondence table 315.

The server pre- and post-update correspondence table 315 includes a column of after extension or reduction 601 and a column of before extension or reduction 602. The column of before extension or reduction 602 indicates the identifiers of the data store servers 106 provided before the system update.

The column of after extension or reduction 601 indicates the data store server(s) 106 to be allocated messages that have been allocated to the data store server(s) 106 indicated in the column of before extension or reduction 602, after the system update.

Each queue management server 105 holds the server pre- and post-update correspondence table 215 when system update in this embodiment is in process and does not hold the server pre- and post-update correspondence table 215 when the queue management server 105 acquires messages from the post-update distributed queues after completion of the system update in this embodiment.

The server pre- and post-update correspondence table 315 in FIG. 6 includes only two columns of after extension or reduction 601 and before extension or reduction 602. However, when another data store server 106 is added or removed when a data store server 106 is being added or removed, the server pre- and post-update correspondence table 315 may include three or more columns.

FIG. 7 is an explanatory diagram for illustrating the agreement information 213 in each queue management server 105 and the agreement information 313 in the representative data store server in this embodiment.

Since the agreement information 213 and the agreement information 313 have the identical information, the following is a description about the configuration of the agreement information 313. The agreement information 313 includes IP addresses of the queue management servers 105 that have completed preparation for system update, for example.

However, the agreement information 313 in this embodiment can include any information as far as the information indicates whether all the queue management servers 105 have completed preparation for system update. For example, if each queue management server 105 has information on the total number of queue management servers 105, the agreement information 313 may indicate the number of queue management servers 105 that have completed preparation for system update.

FIG. 8 is a sequence diagram for illustrating processing to extend the system in this embodiment.

When the operation management server 107 receives an instruction to update the system from the operator or administrator of the system, or when a data store server 106 has physically been added or removed in accordance with determination of a load monitoring function of the operation management server 107 that the system needs to be updated, the operation management server 107 sends a request for system update to data store servers 106. Although FIG. 8 particularly illustrates extension of the system, reduction can be performed in a similar sequence.

The operation management server 107 sends a data store server extension request including the configuration information on the physically added data store server 106 (hereinafter, new data store server 106N) to the existing data store servers 106 (inclusive of the representative data store server) and the new data store server 106N (701).

The data store server programs 304 in the existing data store servers 106 and the new data store server 106N execute extension processing in accordance with the configuration information included in the received extension request (702). Specifically, each data store server program 304 updates the data store server configuration information 311 by storing information such as the IP address of the new data store server 106N to the data store server configuration information 311 in accordance with the configuration information included in the received extension request.

Furthermore, the data store server programs 304 in the existing data store servers 106 and the new data store server 106N update the data store server coordination information 312 through communication among all the data store servers 106 at Sequence 702.

After Sequence 702, the data store server programs 304 in the existing data store servers 106 and the new data store server 106N return a response to the extension request at Sequence 701 to the operation management server 107 (703).

It should be noted that, at Sequence 702, the data store servers 106 do not relocate messages stored to themselves before Sequence 702 to the new data store server 106N or any other data store server 106. Accordingly, situations such as suspension of acquiring a message do not happen; the service will not stop.

After Sequence 703, the operation management server 107 sends a system extension request to all the queue management servers 105 (704).

The extension request at Sequence 704 includes information such as the IP address of the new data store server 106N. Furthermore, the extension request at Sequence 704 includes information indicating the correspondence relations between the data store servers 106 that have stored messages before the system extension and the data store servers 106 to store messages after the system extension (corresponding to the server pre- and post-update correspondence table 215) to create the server pre- and post-update correspondence table 315. This information on the correspondence relations does not need to be included if the distribution policy information 218 includes pre-registered message allocation policies in the case of system extension, because the server pre- and post-update correspondence table 315 can be created automatically.

Upon receipt of the system extension request, the message processing program 204 of each queue management servers 105 prepares for update of the configuration information such as the data store server configuration information 211 and the data store server coordination information 212 (705).

Specifically, the message processing program 204 creates new data store server configuration information 211 and data store server coordination information 212 to be used after the extension in accordance with the extension request to prepare for update of the configuration information. In this event, the message processing program 204 stores a key range assigned to the new data store server 106N to the new data store server configuration information 211.

In this processing, the message processing program 204 assigns the key range to the new data store server 106N not to duplicate with the key ranges already stored. This processing of the message processing program 204 eliminates relocation of messages among the data store servers 106 or a situation that a message cannot be acquired.

Furthermore, the message processing program 204 in each queue management servers 105 prepares a server pre- and post-update correspondence table 215 in accordance with the extension request (706). Specifically, the message processing program 204 creates a new server pre- and post-update correspondence table 215 in accordance with the extension request to prepare for the system update.

After Sequence 706, since preparation for the system extension has been started, the message processing program 204 in each queue management server 105 sends the new server pre- and post-update correspondence table 215 to the representative data store server and further, sends a request to store the new server pre- and post-update correspondence table 215 as a server pre- and post-update correspondence table 315 to the representative data store server (707).

The message processing program 204 in each queue management server 105 receives a response to Sequence 707 from the representative data store server (708).

The message processing program 204 determines whether the response received at Sequence 708 indicates the storing is successful. If the response at Sequence 708 indicates that the storing is successful, the message processing program 204 proceeds to Sequence 712.

If the response at Sequence 708 indicates that the representative data store server already has the server pre- and post-update correspondence table 315 and the storing the server pre- and post-update correspondence table 315 is failed, the server pre- and post-update correspondence table 315 of the representative data store server has been created by the message processing program 204 of another queue management server 105.

Accordingly, when the response at Sequence 708 indicates that the storing the server pre- and post-update correspondence table 315 is failed, the message processing program 204 requests the server pre- and post-update correspondence table 315 of the representative data store server (709) to acquire the server pre- and post-update correspondence table 315 from the representative data store server (710).

After Sequence 710, the message processing program 204 determines whether the server pre- and post-update correspondence table 215 stored in the queue management server 105 is identical to the acquired server pre- and post-update correspondence table 315 (711).

If the server pre- and post-update correspondence table 215 is identical to the acquired server pre- and post-update correspondence table 315, the message processing program 204 proceeds to Sequence 712. If the server pre- and post-update correspondence table 215 is not identical to the acquired server pre- and post-update correspondence table 315, the message processing program 204 aborts the processing in FIG. 8. The message processing program 204 may send information indicating an error to the operation management server 107.

If the response at Sequence 708 indicates that the storing is successful or if the server pre- and post-update correspondence table 215 is identical to the acquired server pre- and post-update correspondence table 315, the message processing program 204 requests the new data store server 106N to create a 1st queue 317 and a 2nd queue 318 including one or more distributed queue data groups 321 (inclusive of distributed queue management information 331) (712).

The data store server program 304 of the new data store server 106N creates a 1st queue 317 and a 2nd queue 318 including one or more distributed queue data groups 321 (inclusive of distributed queue management information 331) in its local volatile storage unit 305 in accordance with the request.

After the new data store server 106N has created distributed queues such as the 1st queue 317, the message processing program 204 receives a response to the request to create distributed queues (713). If the response at Sequence 713 indicates the creating the distributed queues is successful or that the distributed queues have already been created, the message processing program 204 invokes Sequence 714.

If the response at Sequence 713 indicates that the creating the distributed queues is failed and that no distributed queue has been created, the message processing program 204 aborts the processing in FIG. 8 The message processing program 204 may send information indicating an error to the operation management server 107.

At Sequence 714, the message processing program 204 of each queue management server 105 sends a request to acquire the agreement information 313 to the representative data store server (714). The message processing program 204 of each queue management server 105 receives a response including the agreement information 313 from the representative data store server (715).

The message processing program 204 of each queue management server 105 updates the agreement information 213 with the agreement information 313 received from the representative data store server (716).

After Sequence 716, the message processing program 204 of each queue management server 105 updates the agreement information 313 of the representative data store server with its own agreement information 213 (717). In this event, the message processing program 204 updates the agreement information 313 and 213 by storing information such as the IP address of the queue management server 105 running the message processing program 204 itself to the agreement information 313 and 213. Through this processing, information for identifying the queue management servers 105 that have completed preparation for the system extension is stored in the agreement information 313.

After Sequence 717, the message processing program 204 of each queue management server 105 receives a response indicating completion of update of the agreement information from the representative data store server (718). When the message processing program 204 of each queue management server 105 completes the processing up to Sequence 718, the message processing program 204 sends a response indicating completion of preparation for the extension to the operation management server 107 (719). The operation management server 107 receives responses at Sequence 719 from all the queue management servers 105.

In the meanwhile, the message processing program 204 of each queue management server 105 acquires the agreement information 313 from the representative data store server when the message processing program 204 allocates a message received after Sequence 719 to a data store server 106 or when the message processing program 204 checks the conditions of the data store servers 106 at a scheduled time. The message processing program 204 determines whether the status of the queue management servers 105 is “in agreement”, meaning that all the queue management servers 105 have completed preparation for extension (720).

Specifically, the message processing program 204 determines that the status of the queue management servers 105 is “in agreement” if the agreement information 313 includes information identifying all the queue management servers 105. In order to determine whether all the queue management servers 105 have completed preparation for the extension with reference to the agreement information 313, the message processing program 204 may hold the IP addresses of all the queue management servers 105 or the total number of queue management servers 105.

The message processing program 204 does not use the new data store server configuration information 211 and data store server coordination information 212 created at Sequence 705 and the new server pre- and post-update correspondence table 215 created at Sequence 706 until determining that the status of the queue management servers 105 is “in agreement”. Accordingly, the message processing program 204 determines where to acquire or where to store a message in the same way as before the system extension.

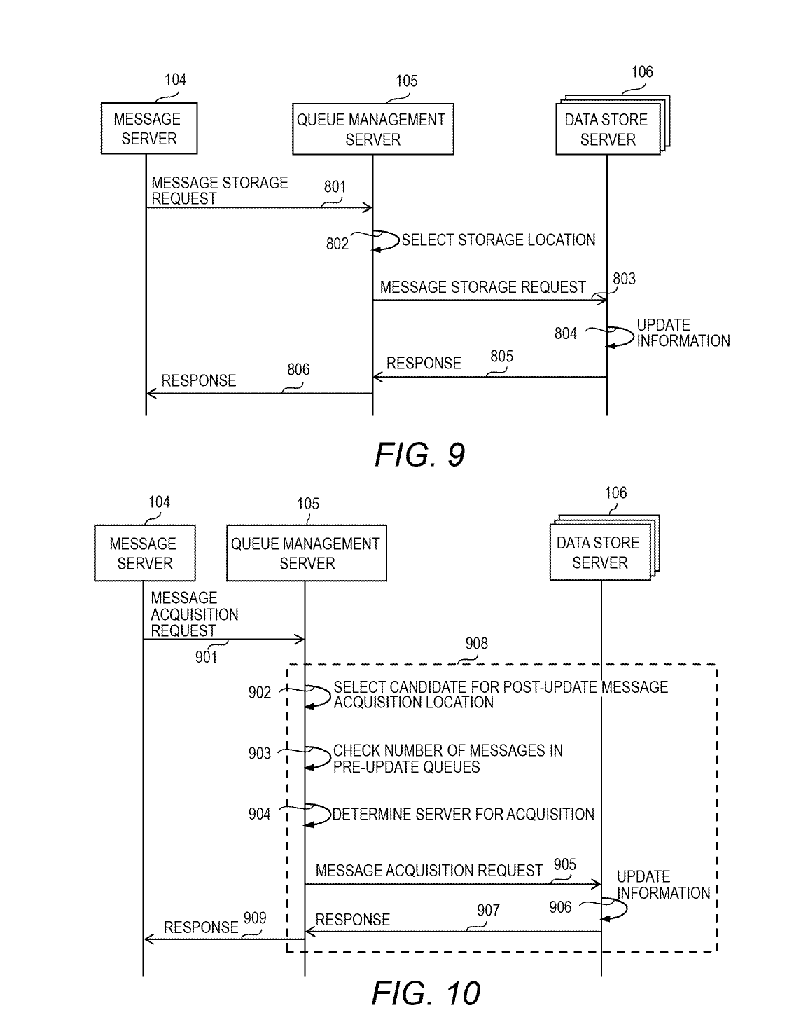

Upon determination that the status of the queue management servers 105 is “in agreement”, the message processing program 204 updates the previous data store server configuration information 211 and data store server coordination information 212 with the new data store server configuration information 211 and data store server coordination information 212. As a result, the message processing program 204 changes the processing mode to determine where to acquire or where to store a message into the one using the determination method illustrated in FIGS. 9 and 10 for the time when system update is in process. FIGS. 9 and 10 will be described later (721).

At Sequence 721, the message processing program 204 further updates the policies for the consistent hashing in the distribution policy information 218 if necessary, in view of the update of the data store server configuration information 211.

At Sequence 721, the message processing program 204 further updates the latest message-storage-queue information 502 in the pre- and post-update queue information 214 to indicate a different distributed queue. The message processing program 204 also increments the sequence number 501 by one. As a result, the distributed queue to store the messages after the completion of preparation for the system update becomes different from the distributed queue having stored messages before the start of the preparation for system update.

After Sequence 721, the message processing program 204 of each queue management server 105 sends a response indicating that the queue management server 105 starts processing for the time when system update is in process to the operation management server 107 (722). The changing the status to “system update in process” after determining that the status is “in agreement” enables synchronization of the processing among the plurality of queue management servers 105.

In the case of reducing the system using the processing in FIG. 8, Sequences 701 to 703 in FIG. 8 are not performed. Sequences 704 to 722 are performed while the extension of the system is replaced with reduction of the system. Thereafter, the message processing program 204 of each queue management server 105 processes all the messages in the pre-reduction queues in the data store server 106 to be removed and after all the messages have been processed, the operation management server 107 issues reduction requests to all the data store servers 106.

FIG. 9 is a sequence diagram for illustrating processing to store a message sent from a message server 104 to a data store server 106 in this embodiment.

The message processing program 204 of a queue management server 105 receives a message and a request to store the message from a message server 104 (801).

After Sequence 801, the message processing program 204 selects the identifier of a distributed queue data group pair 321 of a data store server 106 to store the message (hereinafter, destination data store server) based on the distribution policy information 218, the in-order guarantee key 404, and the target queue name 403.

The message processing program 204 selects the distributed queue indicated in the latest message-storage-queue information 502 of the pre- and post-update queue information 214 as the distributed queue to store the message (802). Through this processing, the message processing program 204 determines the distributed queue (the 1st queue 317 or the 2nd queue 318) and the distributed queue data group 321 in the distributed queue to store the message.

In this connection, if a plurality of messages in need of in-order guarantee are separately stored in a plurality of data store servers 106, the message processing program 204 has to compare the sequence numbers or times of processing the messages. To avoid such a situation, the message processing program 204 selects the same queue in the same data store server 106 for the plurality of messages having the same in-order guarantee key 404 as the destination queue in the destination data store server.

Furthermore, if Sequence 802 is invoked during system update or after system update and if the destination queue before the start of the system update is the 1st queue 317, the message processing program 204 selects the 2nd queue 318 as the destination queue for the time when system update is in process. If Sequence 802 is invoked during system update or after system update and if the destination queue before the start of the system update is the 2nd queue 318, the message processing program 204 selects the 1st queue 317 as the destination queue for the time when system update is in process.

As a result, the message processing program 204 can eliminate messages stored before start of the system update from being mixed up with messages stored during the system update in the same distributed queue data group 321 in the same distributed queue. That is to say, Sequence 802 is a prerequisite for the data store server 106 to process the messages stored before the start of the system update first even if the system receives message storage requests during the system update.

After Sequence 802, the message processing program 204 sends a request to store a message to the destination queue together with the message to the destination data store server (803). The request to be sent in this processing includes information for identifying the destination queue.

Upon receipt of the request to store the message, the data store server program 304 stores the received message to the distributed queue data group 321 of the distributed queue in the volatile storage unit 305 and further, updates the distributed queue management information 331 in accordance with the received request and the target queue name 403 (804).

At Sequence 804, the data store server program 304 increments the number of messages stored in the distributed queue and updates information such as the processing order (or storage order) of the messages in the distributed queue management information 311.

After Sequence 804, the data store server program 304 of the destination data store server sends a response to the request to store the message at Sequence 803 to the queue management server 105 (805). After Sequence 805, the message processing program 204 of the queue management server 105 returns a response to the request to store the message to the message server 104 (806).

FIG. 10 is a sequence diagram for illustrating processing to acquire one or more messages for a message server 104 in this embodiment.

The message processing program 204 of a queue management server 105 receives a request (message acquisition request) to acquire one or more messages from the data store servers 106 from a message server 104 (901). The message acquisition request in this embodiment includes the number of messages to be acquired.

Upon receipt of the message acquisition request, the message processing program 204 selects a candidate for the data store server 106 where to acquire the message(s) (hereinafter, post-update message acquisition location) with reference to the acquisition policy information 219. The candidate to be selected in this event is a data store server 106 from which the queue management server 105 is to acquire messages after system update.

If the message acquisition request requests to acquire a plurality of messages, the message processing program 204 may select a plurality of post-update message acquisition locations in accordance with the number of messages to be acquired.

Subsequently, the message processing program 204 refers to the server pre- and post-update correspondence table 215 and identifies the data store server 106 indicated in the column of before extension or reduction 602 of the entry that holds the selected candidate in the column of after extension or reduction 601 (902). The identified data store server 106 here is referred to as pre-update message acquisition location.

After Sequence 902, the message processing program 204 refers to the pre- and post-update queue information 214 and identifies the distributed queue (the 1st queue 317 or the 2nd queue 318) different from the distributed queue indicated in the latest message-storage-queue information 502 as pre-update queue for acquisition.

The message processing program 204 determines whether the number of messages stored in the pre-update queue for acquisition in the pre-update message acquisition location is zero based on the identified pre-update queue for acquisition, the pre-update message acquisition location identified at Sequence 902, and the pre- and post-update queue information 214 (903).

Specifically, if the table indicating the number of messages stored in the pre-update queue for acquisition in the pre-update message acquisition location includes at least one element indicating a number greater than zero, the message processing program 204 determines that the number of messages stored in the pre-update queue for acquisition in the pre-update message acquisition location is not zero.

If the number of messages stored in the pre-update queue for acquisition in the pre-update message acquisition location is zero, the distributed queue used before the system update no longer includes any message. Accordingly, the message processing program 204 determines the candidate post-update message acquisition location to be the data store server 106 where to acquire the message(s) and determines the distributed queue indicated in the latest message-storage-queue information 502 to be the distributed queue where to acquire the message(s).

If the number of messages stored in the pre-update queue for acquisition in the pre-update message acquisition location is not zero and is one or more, the distributed queue used before system update still includes one or more messages; the message processing program 204 needs to acquire the message(s) preferentially from this distributed queue. Accordingly, the message processing program 204 determines the pre-update message acquisition location and the pre-update queue for acquisition to be the data store server 106 and the distributed queue where to acquire the message(s).

In this connection, if a plurality of post-update message acquisition locations and a plurality of pre-update message acquisition locations are determined and further, if all the number of messages in the distributed queues in the determined plurality of pre-update message acquisition locations are not zero, the message processing program 204 may determine the message acquisition location in accordance with the policies predetermined in the acquisition policy information 219. The acquisition policy information 219 may designate a method to select one of the data store servers 106 of pre-update message acquisition locations by round-robin, for example.

Sequences 902 to 904 enable the message processing program 204 to acquire a message preferentially from the pre-update queue for acquisition in the pre-update message acquisition location if the pre-update queue for acquisition in the pre-update message acquisition location still includes at least one unprocessed message. Accordingly, the queue management server 105 can output messages without stopping the service provided by the distributed message system while ensuring the order of the messages that have stored before the system update.

After Sequence 904, the message processing program 204 sends an acquisition request for one or more messages to the data storage server 106 determined at Sequence 904 (905). The message processing program 204 includes information for identifying the distributed queue where to acquire the message(s) in the acquisition request at Sequence 905.

The data store server program 304 updates the distributed queue management information 331 in the distributed queue designated by the acquisition request (906). Specifically, the data store server program 304 decrements the number of messages in the distributed queue included in the distributed queue management information 331 by the number of messages to be outputted to the queue management server 105 and updates the information on the message processing order (storage order) included in the distributed queue management information 331.

After Sequence 906, the data store server program 304 sends a response including the message(s) designated by the acquisition request and acquired from the distributed queue to the queue management server 105 (907).

If the message processing program 204 cannot acquire the requested number of messages from the determined message acquisition location because the message acquisition request from the message server 104 requests for a large number of messages and further, if the acquisition policy information 219 designates a method such as round-robin, the message processing program 204 may repeat the processing from Sequence 902 to Sequence 907 while changing the post-update message acquisition location by round-robin (908).

At the end, the message processing program 204 of the queue management server 105 sends a response including the message(s) acquired from the data store server(s) 106 (909).

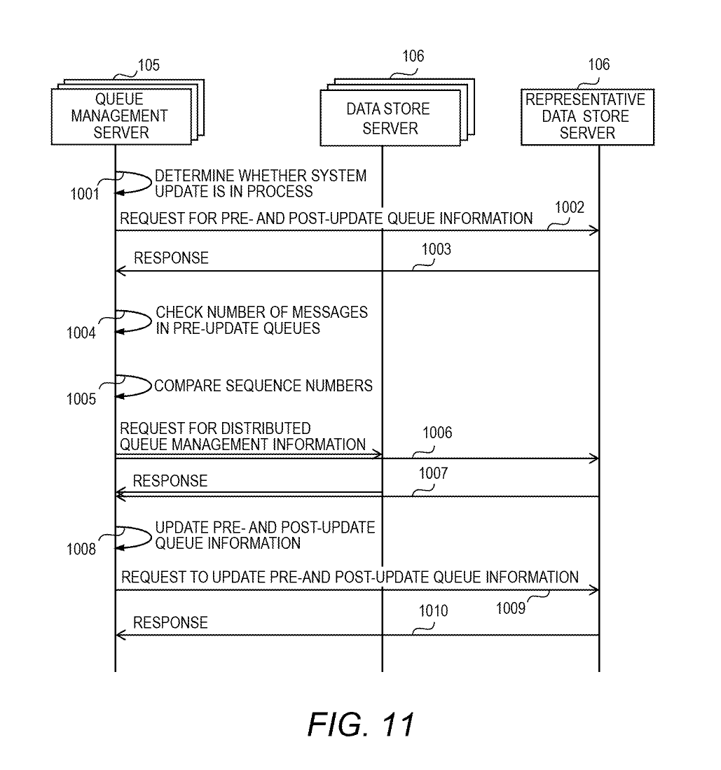

FIG. 11 is a sequence diagram for illustrating processing to update the pre- and post-update queue information (214, 314) in each queue management server 105 in this embodiment.

The processing in FIG. 11 is performed with a predetermined interval, for example, one second. The higher the frequency to update the pre- and post-update queue information (214, 314), the shorter the time to detect a change in the number of messages that have been stored before system update or the time to detect that the number of messages has become zero; accordingly, the time to switch the locations to acquire messages from the pre-update distributed queue to the post-update distributed queue decreases as well. In the meanwhile, the updating the pre- and post-update queue information (214, 314) increases the load to the CPU and accordingly, the possibility of degradation in throughput increases.

The distributed message system in this embodiment determines the frequency of updating the pre- and post-update queue information 214, 314 in consideration of such conditions.

The message processing program 204 in each queue management server 105 determines whether the distributed message system in this embodiment is in process of system update by determining whether the server pre- and post-update correspondence table 215 exists (1001). If the volatile storage unit 205 does not include a server pre- and post-update correspondence table 215, the message processing program 204 determines that the system is not in process of update and exits the processing in FIG. 11.

That is to say, the processing subsequent to Sequence 1002 in FIG. 11 is performed particularly after Sequence 722 in FIG. 8.

If the volatile storage unit 205 includes a server pre- and post-update correspondence table 215, the message processing program 204 determines that the system is in process of update and invokes the next Sequence 1002. If the server pre- and post-update correspondence table 215 is not deleted after completion of system update, the message processing program 204 may hold a flag indicating whether the system is in process of update and determine whether the system is in process of update with reference to this flag.

At Sequence 1002, the message processing program 204 sends a request for the pre- and post-update queue information 314 to the representative data store server. After Sequence 1002, the message processing program 204 receives a response including the pre- and post-update queue information 314 from the representative data store server (1003).

The message processing program 204 refers to the local pre- and post-update queue information 214 in the queue management server 105 and identifies the distributed queue different from the distributed queue indicated in the latest message-storage-queue information 502 as the distributed queue that have stored messages before the system update.

The message processing program 204 selects the queue message counter table for the identified distributed queue, namely the 1st queue message counter table 503 or the 2nd queue message counter table 504, from the pre- and post-update queue information 314 acquired from the representative data store server and determines whether all the elements in the selected table are 0.

If all the elements in the selected table are 0, the message processing program 204 determines that the system update is completed and determines to acquire messages from the post-update distributed queue as normal.

If the message processing program 204 determines to acquire messages from the post-update distributed queue as normal, the message processing program 204 deletes the server pre- and post-update correspondence table 215. Further, if the latest message-storage-queue information 502 in the pre- and post-update queue information 314 is different from the latest message-storage-queue information 502 in the pre- and post-update queue information 214, the message processing program 204 instructs the representative data store server to update the latest message-storage-queue information 502 in the pre- and post-update queue information 314 with the latest message-storage-queue information 502 in the pre- and post-update queue information 214 and to increment the sequence number 501 by one, and exits the processing in FIG. 11.

If the table elements include at least one positive number, the message processing program 204 determines that the system is in process and proceeds to the next Sequence 1005.

At Sequence 1005, the message processing program 204 compares the sequence number 501 in the pre- and post-update queue information 214 with the sequence number 501 in the pre- and post-update queue information 314 acquired from the representative data store server. If the sequence number 501 in the pre- and post-update queue information 214 is smaller than (or older than) the sequence number 501 in the pre- and post-update queue information 314, the message processing program 204 updates the pre- and post-update queue information 214 with the pre- and post-update queue information 314 and exits the processing in FIG. 11.

Sequence 1005 means that the pre- and post-update queue information 314 is to be updated by any one queue management server 105, instead of all the queue management servers 105.

If, in the comparison of the sequence numbers at Sequence 1005, the sequence number 501 in the pre- and post-update queue information 214 is not smaller than the sequence number 501 in the pre- and post-update queue information 314, the message processing program 204 requests all the data store servers 106 to send the distributed queue management information 331 (1006). The data store server program 304 in each data server 106 sends a response including its own distributed queue management information 331 to the queue management server 105 of the requestor (1007).

After Sequence 1007, the message processing program 204 updates the 1st queue message counter table 503 and the 2nd queue message counter table 504 in the pre- and post-update queue information 214 based on the distributed queue management information 331 sent from all data store servers 106 and further, adds one to the sequence number 501 in the pre- and post-update queue information 214 (1008).

This processing enables the message processing program 204 to determine the location to acquire or store messages with reference to the pre- and post-update queue information 214 based on the latest conditions of the data store servers 106 during the processing of FIGS. 9 and 10.

After Sequence 1008, the message processing program 204 sends an update request including the updated pre- and post-update queue information 214 to the representative data store server (1009).

The data store server program in the representative data store server updates the pre- and post-update queue information 314 with the pre- and post-update queue information 214 included in the received update request. The data store server program 304 in the representative data store server sends a response indicating completion of the update of the pre- and post-update queue information 314 to the queue management server 105 that has sent the update request (1010).

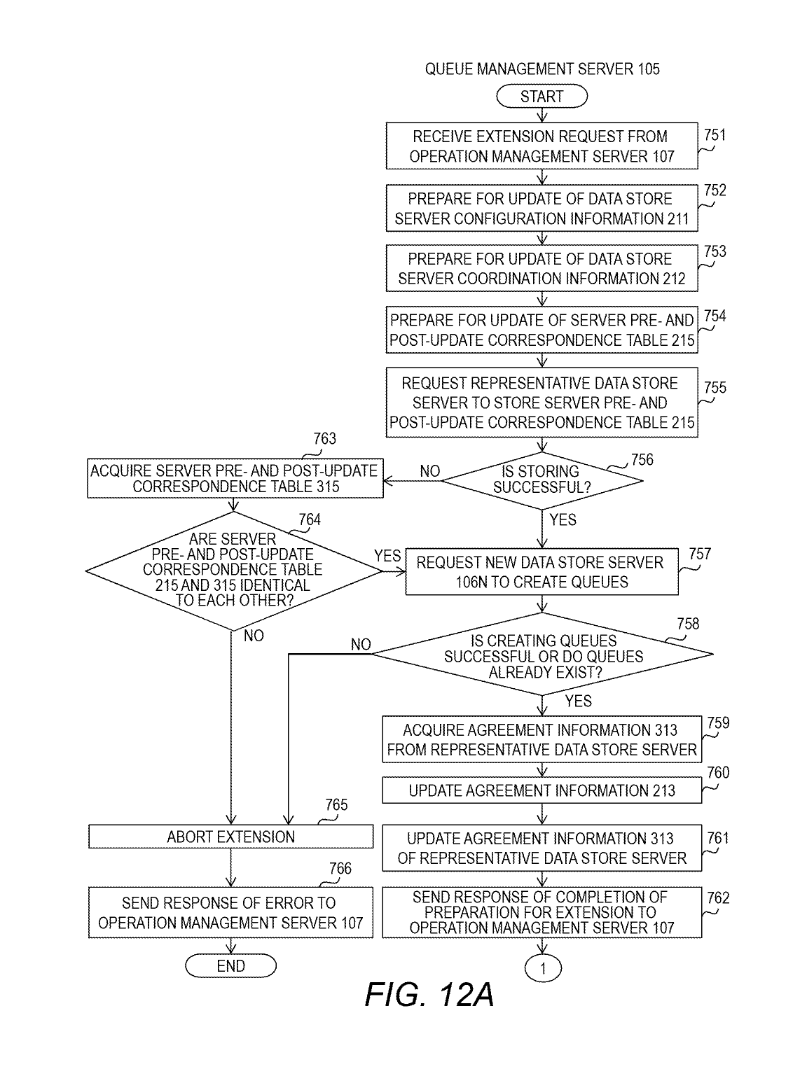

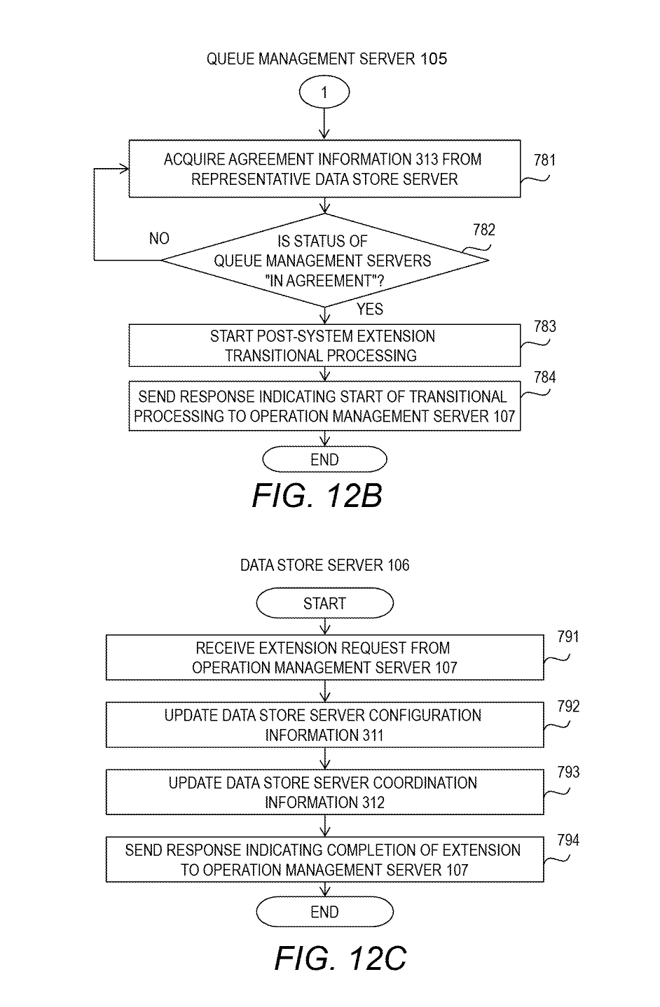

FIG. 12A is a flowchart of preparation for system extension, which is to be performed by a queue management server 105 in this embodiment.

The processing in FIG. 12A corresponds to the processing in FIG. 8 and particularly, corresponds to the processing until Sequence 719 performed by one queue management server 105. Step 751 corresponds to Sequence 704. Steps 752 and 753 correspond to Sequence 705. Step 754 corresponds to Sequence 706. Step 755 corresponds to Sequence 707.

After Step 755, the message processing program 204 determines whether the response at Sequence 708 indicates that the storing is successful (756). If the response at Sequence 708 indicates that the storing is successful, the message processing program 204 performs Step 757. If the response at Sequence 708 does not indicate that the storing is successful, the message processing program 204 performs Step 763.

Step 757 corresponds to Sequence 712. After Step 757, the message processing program 204 determines whether the response at Sequence 713 indicates either that the creating distributed queues is successful or that the distributed queues have already been created (758).

If the response at Sequence 713 indicates either that the creating distributed queues is successful or that the distributed queues have already been created, the message processing program 204 performs Step 759. If the response at Sequence 713 indicates that the creating distributed queues is failed and that the distributed queues have not been created, the message processing program 204 performs Step 765.

Step 759 corresponds to Sequences 714 and 715. Step 760 corresponds to Sequence 716. Step 761 corresponds to Sequences 717 and 718. Step 762 corresponds to Sequence 719.

Step 763 corresponds to Sequences 709 and 710. Step 764 corresponds to Sequence 711. If the determination at Step 764 is that the server pre- and post-update correspondence table 215 is not identical to the acquired server pre- and post-update correspondence table 315, or if the determination at Step 758 is that the response at Sequence 713 indicates that the creating distributed queues is failed and that the distributed queues have not been created, the message processing program 204 aborts the system extension (765).

After Step 765, the message processing program 204 sends a response indicating an error to the operation management server 107 (766) and thereafter, terminates the processing in FIG. 12A.

FIG. 12B is a flowchart of determining whether the preparation for system extension is completed, which is to be performed by a queue management server 105 in this embodiment.

The processing in FIG. 12B corresponds to the processing in FIG. 8 and particularly, corresponds to the processing from Sequences 720 to 722. After Step 762, the message processing program 204 acquires the agreement information 313 from the representative data store server when the message processing program 204 allocates a message to a data store server 106 or checks the conditions of the data store servers 106 at a scheduled time (781).

After Step 781, the message processing program 204 performs Step 782. Step 782 corresponds to Sequence 720. If the determination at Step 782 is that the status is “in agreement”, the message processing program 204 performs Step 783. Step 783 corresponds to Sequence 721 and Step 784 corresponds to Sequence 722.

If the determination at Step 782 is that the status is not “in agreement”, the message processing program 204 returns to Step 781 to acquire the agreement information 313.

FIG. 12C is a flowchart of system extension, which is to be performed by a data store server 106 in this embodiment.

The processing in FIG. 12C corresponds to the processing in FIG. 8 and particularly, corresponds to the processing performed by each of the data store servers 106. Step 791 corresponds to Sequence 701. Steps 792 and 793 correspond to Sequence 702. Step 794 corresponds to Sequence 703.

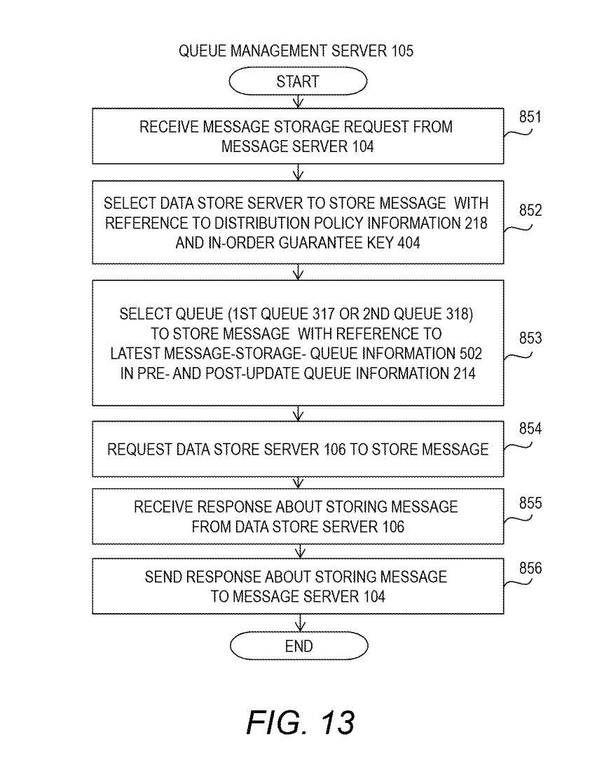

FIG. 13 is a flowchart of storing a message sent from a message server 104 to a data store server 106 in this embodiment.

The processing in FIG. 13 corresponds to the processing in FIG. 9 and particularly, corresponds to the processing performed by a queue management server 105. Step 851 corresponds to Sequence 801. Steps 852 and 853 correspond to Sequence 802.

Step 854 corresponds to Sequence 803. Step 855 corresponds to Sequence 805. Step 856 corresponds to Sequence 806.

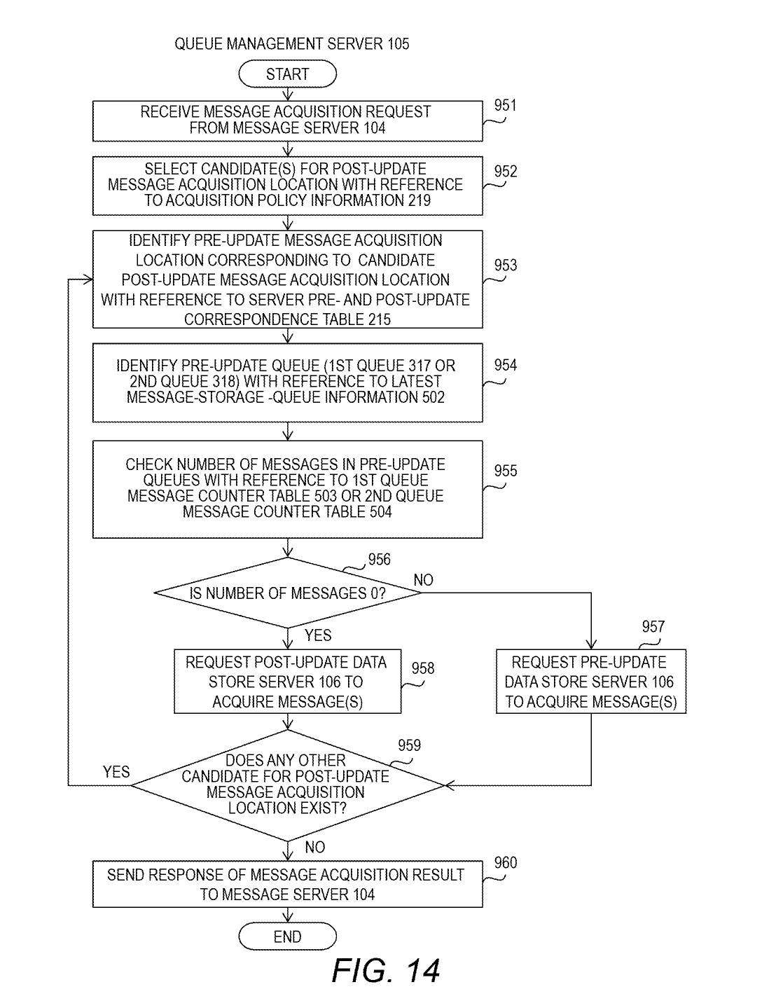

FIG. 14 is a flowchart of acquiring one or more messages for a message server 104 in this embodiment.

The processing in FIG. 14 corresponds to the processing in FIG. 10 and, particularly, corresponds to the processing performed by a queue management server 105. Step 951 corresponds to Sequence 901 in FIG. 10. Steps 952 and 954 correspond to Sequence 902 in FIG. 10.

Specifically, at Step 952, the message processing program 204 selects a candidate for the post-update message acquisition location from which the message(s) are to be acquired with reference to the acquisition policy information 219. At this step, the message processing program 204 may selects a plurality of candidates for the post-update message acquisition locations.

At Step 953, the message processing program 204 determines a pre-update message acquisition location corresponding to the candidate post-update message acquisition location with reference to the server pre- and post-update correspondence table 215.

Steps 955 and 956 correspond to Sequence 903 in FIG. 10.

If the determination at Step 956 is that the number of messages stored in the pre-update queue for acquisition in the pre-update message acquisition location is zero, the message processing program 204 determines the candidate post-update message acquisition location to be the data store server 106 where to acquire the message(s) and sends an acquisition request for one or more messages to the determined data store server 106 (958).

If the determination at Step 956 is that the number of messages stored in the pre-update queue for acquisition in the pre-update message acquisition location is one or more, the message processing program 204 determines the pre-update message acquisition location to be the data store server 106 where to acquire the message(s) and sends an acquisition request for one or more messages to the determined data store server 106 (957).

Step 958 corresponds to Sequence 904 and 905. Step 957 also corresponds to Sequence 904 and 905.

After Step 958 or 957, if the message processing program 204 selects a plurality of candidates for the post-update message acquisition locations at Step 952 and in addition, if the message processing program 204 has not acquired as many messages as the number designated in the acquisition request received at Step 951, the message processing program 204 determines whether any selected candidate post-update message acquisition locations remains for which Steps 954 to 956 have not been performed (959).

If some selected candidate post-update message acquisition location remains for which Steps 954 to 956 have not been performed, the message processing program 204 returns to Step 953. If no selected candidate post-update message acquisition location remains for which Steps 954 to 956 have not been performed, the message processing program 204 sends a response to the request to acquire messages to the message server 104 in accordance with the responses from the data store servers 106, which are results of the processing at Step 958 or 957 (960).

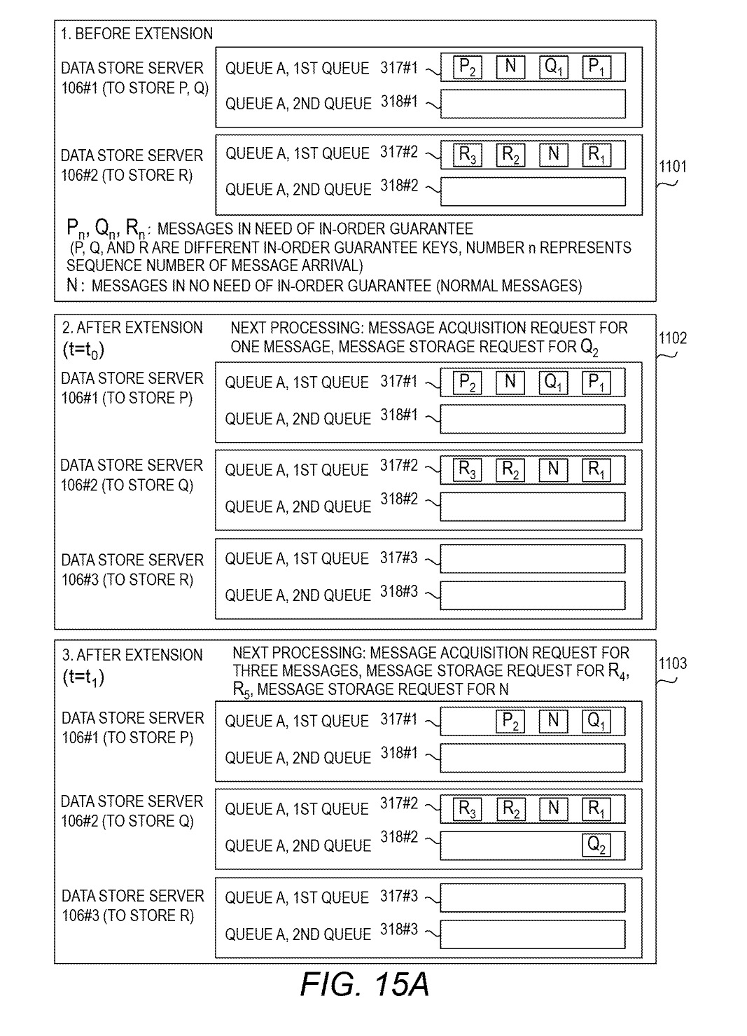

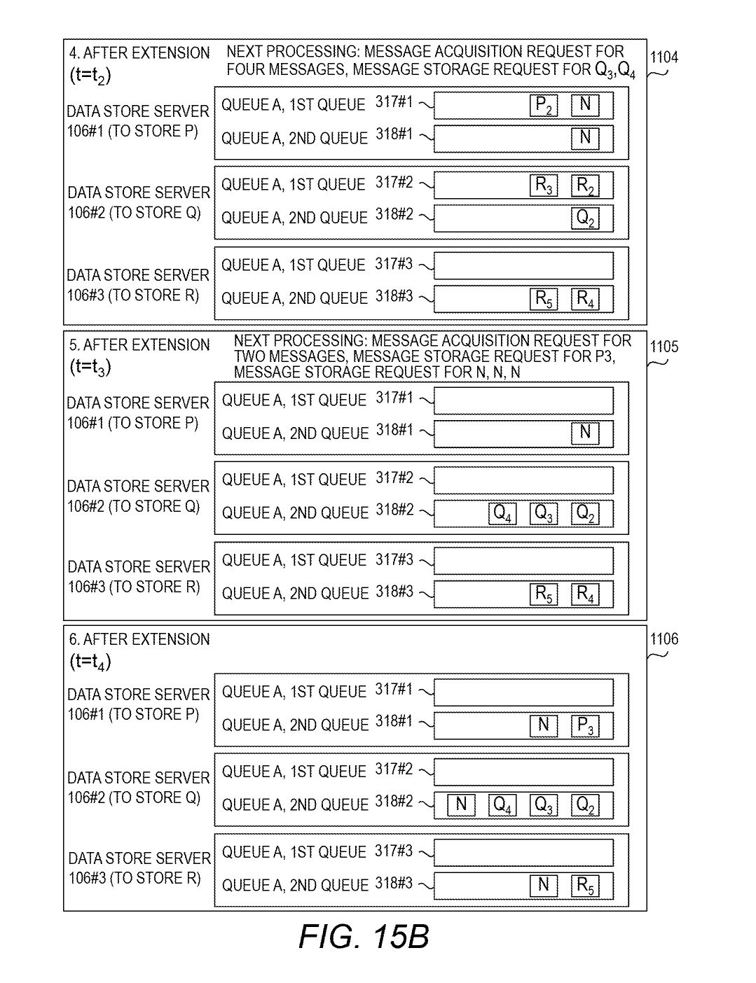

FIG. 15A is an explanatory diagram for illustrating distributed queues in data store servers 106 before and after system extension in this embodiment.

FIG. 15A illustrates distributed queues including stored or acquired messages in chronological order. The phases 1101 to 1103 represent the sequential states of distributed queues. The phase 1101 represents a state of the distributed queues before the system is extended and the phases 1102 and subsequent thereto are states of the distributed queues after the system is extended by adding a data store server 106#3.

The distributed queues shown FIG. 15A are of distributed queue data groups 321A in the 1st queues 317 and the 2nd queues 318 held in the data store servers 106#1, 106#2, and 106#3.

In the example of a system illustrated in FIG. 15A, the distribution policy information 218 before system extension specifies that the distributed queue data group 321A for the 1st queue 317#1 of the data store server 106#1 should store messages including “P” or “Q” in the in-order guarantee key 404 and the distributed queue data group 321A for the 1st queue 317#2 of the data store server 106#2 should store messages including “R” in the in-order guarantee key 404.

In addition, the distribution policy information 218 after system extension specifies that the distributed queue data group 321A for the 2nd queue 318#1 of the data store server 106#1 should store messages including “P” in the in-order guarantee key 404, the distributed queue data group 321A for the 2nd queue 318#2 of the data store server 106#2 should store messages including “Q” in the in-order guarantee key 404, and the distributed queue data group 321A for the 2nd queue 318#3 of the data store server 106#3 should store messages including “R” in the in-order guarantee key 404.

The server pre- and post-update correspondence table 215 in the example of FIG. 15A is the same as the server pre- and post-update correspondence table 215 shown in FIG. 6.

The messages including P, Q, or R in the in-order guarantee key 404 are messages in need of in-order guarantee. The messages denoted by “N” in FIG. 15A are messages not in need of in-order guarantee.

The n's in Pn, Qn, and Rn in FIG. 15A represent sequence numbers in storing the messages, or information held in the distributed queue management information 331.

Phase 1102 shows a state when the system extension is in process after a queue management server 105 receives a system extension request indicating addition of the data store server 106#3 in Phase 1101 and all the queue management servers 105 are in agreement with the system extension.

During the transition from Phase 1101 to Phase 1102, the data store server 106#3 is added and no request to store or acquire a message is issued for the data store servers 106. Accordingly, there is no change in the messages in the 1st queue 317#1 and the 2nd queue 318#1 of the data store server 106#1 and in the 1st queue 317#2 and the 2nd queue 318#2 of the data store server 106#2 between Phases 1101 and 1102.

During the transition from Phase 1102 to Phase 1103, the message processing program 204 of a queue management server 105 receives an acquisition request to acquire one message and a storage request to store one message including “Q” in the in-order guarantee key 404 from a message server 104.

The message processing program 204 invokes Sequence 902 to select the data store server 106#1 as a candidate for the post-update message acquisition location with reference to the acquisition policy information 219.

The acquisition policy information 219 designates a method of selecting a message acquisition location for each message by round-robin for the case of FIG. 15A. Accordingly, the message processing program 204 selects a data store server as a candidate in the order of the data store server 106#1, the data store server 106#2, the data store server 106#3, and then the data store server 106#1.

The message processing program 204 locates the 1st queue 317#1 for the pre-update queue for acquisition in the candidate post-update message acquisition location with reference to the server pre- and post-update correspondence table 215 at Sequence 903 in FIG. 10.

Since the 1st queue 317#1 of the pre-update queue for acquisition still have messages, the message processing program 204 determines to acquire one message (P₁) from the 1st queue 317#1 at Sequence 904.

In the meanwhile, the message processing program 204 stores the message including “Q” in the in-order guarantee key 404 to the distributed queue data group 321A in the 2nd queue 318#2 of the data store server 106#2 at Sequence 803 in FIG. 9 with reference to the distribution policy information 218 (Sequence 802). As a result, the messages are stored as shown in Phase 1103.

FIG. 15B is an explanatory diagram for illustrating distributed queues in data store servers 106 after system extension in this embodiment.

Phases 1104 to 1106 in FIG. 15 are continued from Phase 1103 in FIG. 15A.

During the transition from Phase 1103 to Phase 1104, the message processing program 204 of the queue management server 105 receives two requests from a message server 104. The received requests are an acquisition request to acquire three messages and a storage request to store two messages including “R” in the in-order guarantee key 404 and one message in no need of in-order guarantee.

The message processing program 204 selects the data store servers 106#1, 106#2, and 106#3 as candidates for the post-update message acquisition locations in accordance with the policies specified in the acquisition policy information 219 at Sequence 902 in FIG. 10.

Furthermore, the message processing program 204 locates the 1st queues 317#1 and 317#2 for the pre-update queues for acquisition of the post-update message acquisition locations with reference to the server pre- and post-update correspondence table 215 at Sequence 903. Since the 1st queues 317#1 and 371#2 still have messages, the message processing program 204 determines to acquire one message (Q₁) from the 1st queue 317#1 and two messages (R₁ and N) at Sequence 904.

The method to acquire the messages from the 1st queues 317#1 and 317#2 is specified in the acquisition policy information 219.

In the meanwhile, the message processing program 204 stores the two messages (R₃ and R₄) including “R” in the in-order guarantee key 404 to the distributed queue data group 321A of the 2nd queue 318#3 in the data store server 106#3 at Sequence 803 in FIG. 9 with reference to the distribution policy information 218 (Sequence 802).

The message processing program 204 further stores the one message (N) to the distributed queue data group 321A of the 2nd queue 318#1 in the data store server 106#1 using the round-robin as specified in the distribution policy information 218. As a result, the messages are stored as shown in Phase 1104.

During the transition from Phase 1104 to Phase 1105, the queue management server 105 receives two requests from a message server 104. The two requests are an acquisition request to acquire four messages and a storage request to store two messages including “Q” in the in-order guarantee key 404. In response, the message processing program 204 selects the data store servers 106#1, 106#2, and 106#3 as candidates for the post-update message acquisition locations in accordance with the method specified in the acquisition policy information 219 at Sequence 902 in FIG. 10.

Furthermore, the message processing program 204 locates the 1st queues 317#1 and 317#2 for the pre-update queues for acquisition of the candidate post-update message acquisition locations at Sequence 903. Since the 1st queues 317#1 and 371#2 still have messages, the message processing program 204 determines to acquire two messages (N and P₂) from the 1st queue 317#1 and two messages (R₂ and R₃) at Sequence 904.

In the meanwhile, the message processing program 204 stores the two messages (Q₃ and Q₄) including “Q” in the in-order guarantee key 404 to the distributed queue data group 321A of the 2nd queue 318#2 in the data store server 106#2 at Sequence 803 in FIG. 9 with reference to the distribution policy information 218 (Sequence 802). As a result, the messages are stored as shown in Phase 1105.

During the transition from Phase 1105 to Phase 1106, the queue management server 105 receives two requests from a message server 104. The two requests are an acquisition request to acquire two messages from the distributed queue data group 321A and a storage request to store one message including “P” in the in-order guarantee key 404 and three messages in no need of in-order guarantee.

In response, the message processing program 204 selects the data store servers 106#1 and 106#3 as candidates for the post-update message acquisition locations in accordance with the method specified in the acquisition policy information 219 at Sequence 902 in FIG. 10.

Furthermore, the message processing program 204 locates the 1st queues 317#1 and 317#2 for the pre-update queues for acquisition of the candidate post-update message acquisition locations at Sequence 903. Since the 1st queues 317#1 and 317#2 do not have remaining messages and the 1st queue 317#3 in the data store server 106#3 does not have remaining messages either, the message processing program 204 determines to acquire one message (N) from the 2nd queue 318#1 and one message (R₄) from the 2nd queue 318#3 at Sequence 904.

In the meanwhile, the message processing program 204 stores the one message (P₃) including “P” in the in-order guarantee key 404 to the distributed queue data group 321A of the 2nd queue 318#1 in the data store server 106#1 with reference to the distribution policy information 218 at Sequence 802 in FIG. 9.

Furthermore, the message processing program 204 stores the one message (N) to the distributed queue data group 321A in each of the 2nd queue 318#1, 318#2, and 318#3 by the round-robin as specified in the distribution policy information 218. As a result, the messages are stored as shown in Phase 1106.

When the 1st queues 317 of all the data store servers 106 become empty like Phase 1105, it means elimination of the state where messages in need of in-order guarantee of the distributed queue data groups 321A are distributed in a plurality of data store servers 106. When all the 1st queues 317 become empty for all the distributed queue data groups 321, the system exits the status of “system update in process”.

In exiting the status of “system update in process”, the message processing program 204 performs the processing in FIG. 11 and after determining that all elements in the 1st queue message counter table 503 in the pre- and post-update queue information (214 and 314) are 0, deletes the server pre- and post-update correspondence tables (215 and 315).

FIG. 16 is an explanatory diagram for illustrating an example of a screen 1201 for displaying the specifics of the pre- and post-update queue information 214 in this embodiment.

Every time the values in the pre- and post-update queue information 214 are updated at Sequence 1008, the message processing program 204 may accumulate the pre- and post-update queue information 214 before the update and after the update, and display the screen 1201 as shown in FIG. 16 using the accumulated previous pre- and post-update queue information 214.

The screen 1201 may be displayed on a monitor connected with a queue management server 105 through the input/output circuit interface 202 or a monitor connected with the operation management server 107. The screen 1201 includes areas 1202 to 1205.

The message processing program 204 in the queue management server 105 has an API for displaying the screen 1201 using the information of data store server configuration information 211, pre- and post-update queue information 214, and previous pre- and post-update queue information 214. The operation management server 107 executes the API of the message processing program 204 in the queue management server 105 to render the screen 1201 to display the screen 1201 on its own monitor.

The screen 1201 shown in FIG. 16 is an example of a screen when the distributed message system has been extended from a configuration including two data store servers 106#1 and 106#2 into a configuration including three data store servers.

The area 1202 indicates the current and the maximum number of messages in the entire distributed queues in text or a bar chart separately for each data store server 106. The area 1203 shows scatter graphs that plot the variations in number of messages retained in the entire distributed queues over time inclusive of before and after the system update.

The area 1204 indicates the number of currently unprocessed messages in all the distributed queues out of the messages stored before the system update, separately for each data store server 106. The area 1204 also indicates the number of unprocessed messages in all the distributed queues as of the system update. The area 1204 further indicates the number of currently unprocessed messages in all the distributed queues stored after the system update. The area 1204 shows the values in text or a bar chart.

Regarding the above-described information, the message processing program 204 may display scatter graphs that plot the variations in number of messages over time in the area 1204, although not shown in FIG. 16.

The area 1205 indicates the current and the maximum number of stored messages in text or a bar chart, separately for each distributed queue data group pair 321.

In addition, although not shown in the drawing, the message processing program 204 can show the relation of the processing order of the distributed queues before and after the system update and/or the latest access times of the distributed queues used before the system update in the screen 1201. The message processing program 204 can also show only the text after excluding the charts from the information displayed on the screen 1201 in a file format such as the CSV.

The message processing program 204 can visualize the message processing conditions after system update by displaying the screen 1201. The administrator of the distributed message system may check the message processing conditions during the system update through the screen 1201 and if some distributed queue that have stored messages before the system update still have many unprocessed messages, the administrator may address the situation by executing a forced discharging command, for example.

According to this embodiment, the queue management server 105 stores messages including the identical in-order guarantee keys 404 to the same distributed queue data group 321 in the same data store server 106. And the messages are acquired from the distributed queue data group 321 in order of storage (arrival). Accordingly, the queue management server 105 in this embodiment unfailingly attains in-order guarantee for the messages in need of in-order guarantee without storing a sequence number of the next message to be acquired.

The queue management server 105 in this embodiment has a server pre- and post-update correspondence table 215 for indicating the correspondence relations between the data store servers 106 before system update and the data store servers 106 after system update and chooses the pre-update distributed queue or the post-update distributed queue in each data store server 106 to use to store or acquire a message in the transitional period in system update (in this embodiment, when system update is in process or during system update). This configuration enables the queue management server 105 in this embodiment to add or remove a data store server 106 physically or virtually (namely, to update the system) without stopping the service of the data store servers 106.

The queue management server 105 first acquires messages from the distributed queues used before system update and thereafter, acquires messages from the distributed queues to be used after the system update based on the correspondence relations between the data store servers 106 before system update and the data store servers 106 after system update. This configuration preserves the in-order guarantee when the system update is process.

Although the present disclosure has been described with reference to exemplary embodiments, those skilled in the art will recognize that various changes and modifications may be made in form and detail without departing from the spirit and scope of the claimed subject matter.

The above-described embodiments are explained in detail for better understanding of this invention and are not limited to those including all the configurations and elements described above. A part of the configuration of an embodiment may be replaced with a configuration of another embodiment or a configuration of an embodiment may be incorporated to a configuration of another embodiment. A part of the configuration of each embodiment may be added, deleted, or replaced by that of a different configuration.

The above-described configurations, functions, and processing units, for all or a part of them, may be implemented by hardware: for example, by designing an integrated circuit. The above-described configurations and functions may be implemented by software, which means that a processor interprets and executes programs for providing the functions. The information of programs, tables, and files to implement the functions may be stored in a storage device such as a memory, a hard disk drive, or an SSD (Solid State Drive), or a storage medium such as an IC card, or an SD card.

The drawings show control lines and information lines as considered necessary for explanations but do not show all control lines or information lines in the products. It can be considered that most of all components are actually interconnected.

What is claimed is:

1. A communication system capable of sending and receiving signals, the communication system comprising:
a plurality of data store servers each including a queue capable of storing signals; and
a queue management server capable of allocating signals to the plurality of data store servers,
wherein the queue management server holds distribution policy information that specifies policies to allocate signals to the plurality of data store servers, and
wherein the queue management server is configured to determine to allocate a plurality of received signals to one queue in one of the plurality of data store servers based on the distribution policy information when the plurality of signals include in-order guarantee keys indicating that the plurality of signals are in need of in-order guarantee and the in-order guarantee keys of the plurality of signals are identical.

2. The communication system according to claim 1,
wherein each of the plurality of data store servers holds queue management information that indicates number and storage order of signals stored in the queue,
wherein a data store server is configured to:
update the queue management information when a signal is allocated to a queue in the data store server; and
output a signal stored to the queue at an earliest time to the queue management server with reference to the queue management information upon receipt of a request to acquire a signal from the queue from the queue management server.

3. The communication system according to claim 2,
wherein the plurality of data store servers each include a pre-update queue to be used before the plurality of data store servers are updated in number and a post-update queue to be used after the data store servers are updated in number, and
wherein the queue management server is configured to determine to change where to allocate signals to the post-update queues when the queue management server is notified of update in number of the plurality of data store servers after determining to allocate signals to the pre-update queues.

4. The communication system according to claim 3, wherein the queue management server is configured to:
determine whether the pre-update queues include any signal upon receipt of a request to acquire a signal after determining to change where to allocate signals to the post-update queues; and
acquire a signal from one of the pre-update queues when the pre-update queues include at least one signal.

5. The communication system according to claim 4,
wherein the queue management information in each data store server indicates number of signals stored in the pre-update queue and number of signals stored in the post-update queue,
wherein the queue management server is configured to:
acquire the queue management information from the plurality of data store servers for multiple times; and
output data to display the number of signals stored in the pre-update queues and the number of signals stored in the post-update queues in chronological order based on the acquired queue management information.

6. The communication system according to claim 5, wherein the queue management server is configured to:
acquire the queue management information at predetermined intervals; and
determine whether the pre-update queues include any signal based on the queue management information.

7. The communication system according to claim 3,
wherein the communication system comprises a plurality of queue management servers,
wherein the plurality of data store servers includes a representative data store server,
wherein the representative data store server holds agreement information to indicate whether the plurality of queue management servers are in agreement with update of the system,
wherein each of the plurality of queue management servers is configured to:
update the agreement information when the queue management server agrees with the update in number of the plurality of data store servers notified of; and
determine to change where to allocate signals to the post-update queues when the agreement information indicates that all the plurality of queue management servers are in agreement with the update of the system.

8. The communication system according to claim 1, further comprising a message server capable of including in-order guarantee keys in signals,
wherein the queue management server is configured to receive the signals including the order-guarantee keys from the message server.

9. A queue management server capable of sending and receiving signals and allocating the received signals to a plurality of data store servers each including a queue capable of storing signals,
the queue management server comprising a memory,
wherein the memory holds distribution policy information that specifies policies to allocate signals to the plurality of data store servers, and
wherein the queue management server is configured to determine to allocate a plurality of signals to one queue in one of the plurality of data store servers based on the distribution policy information when the plurality of received signals include in-order guarantee keys indicating that the plurality of signals are in need of in-order guarantee and the in-order guarantee keys of the plurality of signals are identical.

10. The queue management server according to claim 9, wherein the queue management server is configured to determine to change where to allocate signals to post-update queues held in the plurality of data store servers when the queue management server is notified of update of the plurality of data store servers in number after determining to allocate signals to pre-update queues held in the plurality of data servers.

11. The queue management server according to claim 10, wherein the queue management server is configured to:
determine whether the pre-update queues include any signal when the queue management server receives a request to acquire a signal after determining to change where to allocate signals to the post-update queues; and
acquire a signal from one of the pre-update queues when the pre-update queues include at least one signal.

12. The queue management server according to claim 11, wherein the queue management server is configured to:
acquire queue management information that is held in each of the plurality of data store servers and indicates number of signals stored in a pre-update queue and number of signals stored in a post-update queue from the plurality of data store servers for a plurality of times; and
output data to display the number of signals stored in the pre-update queues and the number of signals stored in the post-update queues in chronological order based on the acquired queue management information.

13. The queue management server according to claim 12, wherein the queue management server is configured to:
acquire the queue management information at predetermined intervals; and
determine whether the pre-update queues include any signal based on the queue management information.

14. The queue management server according to claim 10, wherein the queue management server is configured to:
update agreement information held by a representative data store server in the plurality of data store servers when the queue management server agrees with the update in number of the plurality of data store servers notified of; and
determine to change where to allocate signals to the post-update queues when the agreement information indicates that all queue management servers inclusive of the queue management server are in agreement with the update of the system.

15. A communication method for a communication system capable of sending and receiving signals,
the communication system including a plurality of data store servers each including a queue capable of storing signals and a queue management server capable of allocating signals to the plurality of data store servers,
the queue management server including a memory, and
the communication method comprising the steps of:
storing distribution policy information that specifies policies to allocate signals to the plurality of data store servers, and
determining to allocate a plurality of received signals to one queue in one of the plurality of data store servers based on the distribution policy information when the plurality of received signals include in-order guarantee keys indicating that the signals are in need of in-order guarantee and the in-order guarantee keys of the plurality of signals are identical.
